(19) United States
(12) Patent Application Publication
(10) Pub. No.: US 2026/0153650 A1
(43) Pub. Date: Jun. 4, 2026

(54) FILM, PRODUCTION METHOD THEREFOR, AND IMAGE DISPLAY DEVICE

(71) Applicant: KANEKA CORPORATION, Osaka-shi, Osaka (JP)

(72) Inventors: Kohei OGAWA, Settsu-shi (JP); Hiroyuki USHIRO, Settsu-shi (JP); Keisuke KATAYAMA, Settsu-shi (JP); Fumiyasu ISHIGURO, Settsu-shi (JP); Hiroto KOMA, Settsu-shi (JP)

(21) Appl. No.: 18/714,703

(22) PCT Filed: Nov. 28, 2022
(86) PCT No.: PCT/JP2022/043764

§ 371 Date: May 30, 2024

(30) Foreign Application Priority Data
Nov. 30, 2021 (JP) 2021-194540

(51) Int. Cl. G02B 1/14; G02B 1/04

(52) U.S. Cl. CPC G02B 1/14; G02B 1/04

(57) ABSTRACT

The present invention relates to a film containing a polyimide and an acrylic resin. In a film plane, a refractive index n₁ in a first direction in which the refractive index is maximum and a refractive index n₂ in a second direction orthogonal to the first direction satisfy 100×(n₁−n₂)/n₂≥1.0. The total light transmittance of the film is preferably 85% or more, the haze is preferably 10% or less, and the yellowness index is preferably 5 or less. This film can be produced by, for example, stretching a non-stretched film containing a polyimide and an acrylic resin in at least one direction.

### TECHNICAL FIELD

The present invention relates to a film and production method therefor, and an image display device including the film.

### BACKGROUND ART

Electronics devices such as display devices such as liquid crystal displays, organic EL displays and electronic papers, solar cells, and touch panels are required to be thin, lightweight, and flexible. Glass materials that are used for these devices are replaced by film materials to make the devices flexible, thin, and lightweight. As a replacement for glass, a transparent polyimide film has been developed and used for substrates for displays, cover films (cover windows) arranged on the outermost surface of display devices, and the like.

In order to apply such a film to bendable applications such as flexible displays, studies have been made to improve the bending resistance of a transparent polyimide film. For example, Patent Document 1 describes that bending resistance is improved by stretching a polyimide film.

### PRIOR ART DOCUMENT

### Patent Document

Patent Document 1: JP 2019-6933 A

### SUMMARY OF THE INVENTION

### Problems to be Solved by the Invention

Although polyimide is excellent in heat resistance, in order to stretch a polyimide film, it is necessary to heat the film to a high temperature of 250° C. or higher due to a high glass transition temperature of polyimide. Polyimide tends to be colored yellow when heated to a high temperature, and the transparency thereof tends to decrease, and it is not easy to achieve both transparency and high mechanical strength.

In view of the above, an object of the present invention is to provide a transparent film having excellent transparency and excellent mechanical strength applicable to a flexible display.

### Means for Solving the Problems

The present invention relates to a film containing a polyimide and an acryl-based resin and having in-plane refractive index anisotropy. In the film plane, a refractive index n₁ in a first direction in which the refractive index is maximum and a refractive index n₂ in a second direction orthogonal to the first direction satisfy 100×(n₁−n₂)/n₂≥1.0.

The total light transmittance of the film is preferably 85% or more, the haze is preferably 10% or less, and the yellowness index is preferably 5 or less. The glass transition temperature of the film may be 110° C. or higher and lower than 250° C. The ratio of the polyimide resin to the acryl-based resin contained in the film may be 98:2 to 2:98 in terms of the weight ratio.

In an embodiment, the polyimide contained in the film includes, as a tetracarboxylic dianhydride component, one or more tetracarboxylic dianhydrides selected from the group consisting of fluorine-containing aromatic tetracarboxylic dianhydrides and alicyclic tetracarboxylic dianhydrides, and includes, as a diamine component, one or more diamines selected from the group consisting of fluoroalkyl-substituted benzidines and alicyclic diamines.

The polyimide preferably contains fluoroalkyl-substituted benzidine as a diamine component. The amount of the fluoroalkyl-substituted benzidine based on the total amount of the diamine components of the polyimide may be 25 mol % or more. Examples of the fluoroalkyl-substituted benzidine include 2,2′-bis(trifluoromethyl)benzidine.

The amounts of the fluorine-containing aromatic tetracarboxylic dianhydride and the alicyclic tetracarboxylic dianhydride based on the total amount of the tetracarboxylic dianhydride components of the polyimide may be 15 mol % or more.

In an embodiment, in the acryl-based resin contained in the film, the total amount of methyl methacrylate and modified structures of methyl methacrylate based on the total amount of the monomer components is 60 wt % or more. The glass transition temperature of the acryl-based resin may be 90° C. or higher.

In the film, at least one of the tensile modulus in the first direction and the tensile modulus in the second direction may be 4.0 GPa or more.

The film is obtained, for example, by stretching a film (unstretched film) containing polyimide and an acryl-based resin in at least one direction. That is, the film of the present invention may be a stretched film stretched in at least one direction. The temperature during stretching may be lower than 250° C.

In an embodiment, an unstretched film is obtained by applying a resin solution in which a polyimide and an acryl-based resin are dissolved in an organic solvent onto a support, and removing the organic solvent. By stretching this film in at least one direction, a stretched film having refractive index anisotropy is obtained.

### Effects of the Invention

The above-described film is excellent in transparency and has high mechanical strength such as bending resistance, and thus can be suitably used for cover films and the like of flexible displays.

### BRIEF DESCRIPTION OF THE DRAWING

FIG. 1 shows transmission electron microscope images of planes and cross-sections of films of an example and a comparative example.

### MODE FOR CARRYING OUT THE INVENTION

The film according to an embodiment of the present invention contains a polyimide resin and an acryl-based resin, and exhibits transparency because the polyimide resin and the acryl-based resin are compatible with each other. The transparent film of the present invention has refractive index anisotropy in the film plane, and a difference (n₁−n₂) between a refractive index n₁ in a first direction in which an in-plane refractive index of the film is a maximum and a refractive index n₂ in a second direction orthogonal to the first direction is 1% or more of n₂. That is, the in-plane refractive indexes n₁ and n₂ of the film satisfy 100×(n₁−n₂)/n₂≥1.0.

A method for producing a film having refractive index anisotropy is not particularly limited. For example, a film is produced from a resin composition (resin mixture) containing a polyimide resin and an acryl-based resin exhibiting compatibility, and the film is stretched in at least one direction, thereby imparting refractive index anisotropy to the film.

### [Polyimide]

As the polyimide exhibiting compatibility with the acryl-based resin, a polyimide soluble in an organic solvent is preferable. The polyimide soluble in an organic solvent is preferably dissolved in N,N-dimethylformamide (DMF) at a concentration of 1 wt % or more. The polyimide is particularly preferably soluble in a non-amide-based solvent as well as in an amide-based solvent such as DMF.

Polyimide is a polymer having a structural unit represented by general formula (I), and is obtained by cyclodehydration of a polyamic acid obtained by addition polymerization of a tetracarboxylic dianhydride (hereinafter, sometimes referred to as an “acid dianhydride”) with a diamine. That is, the polyimide is a polycondensation product of tetracarboxylic dianhydride and a diamine, and has an acid dianhydride-derived structure (acid dianhydride component) and a diamine-derived structure (diamine component).

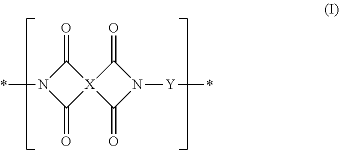

In general formula (I), Y is a divalent organic group, and X is a tetravalent organic group. Y is a diamine residue, and is an organic group obtained by removing two amino groups from a diamine represented by the following general formula (II). X is a tetracarboxylic dianhydride residue, and is an organic group obtained by removing two carboxy anhydride groups from a tetracarboxylic dianhydride represented by the following general formula (III).

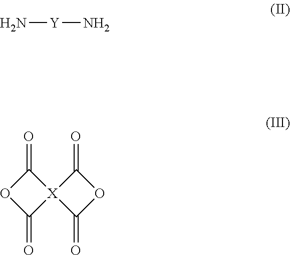

In other words, the polyimide contains a structural unit represented by the following general formula (IIa) and a structural unit represented by the following general formula (IIIa). The diamine-derived structure (IIa) and the tetracarboxylic dianhydride-derived structure (IIIa) form an imide bond, whereby the polyimide has a structural unit represented by the general formula (I).

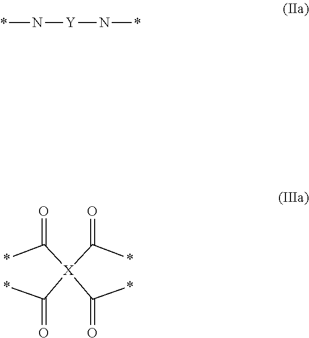

In addition to a method of synthesizing a polyimide from an acid dianhydride and a diamine via a polyamic acid, the polyimide can also be synthesized by condensation or the like through decarboxylation of a diisocyanate and an acid dianhydride. In any of the synthesis methods, the obtained polyimide has an acid dianhydride-derived structure (tetracarboxylic dianhydride residue) X obtained by removing four carboxy groups from a tetracarboxylic dianhydride and a diamine-derived structure (diamine residue) Y obtained by removing two amino groups from a diamine. Therefore, even when the starting material used for synthesis of the polyimide is not an acid dianhydride or a diamine, a structure corresponding to the tetracarboxylic dianhydride residue contained in the polyimide is expressed as an “acid dianhydride component,” and a structure corresponding to the diamine residue is expressed as a “diamine component.”

### <Diamine>

The diamine component of the polyimide is not particularly limited, but from the viewpoint of enhancing compatibility with the acryl-based resin, the polyimide preferably contains at least one of fluoroalkyl-substituted benzidine and alicyclic diamine as the diamine component.

### (Fluoroalkyl-Substituted Benzidine)

Examples of the fluoroalkyl-substituted benzidine include 2-fluorobenzidine, 3-fluorobenzidine, 2,3-difluorobenzidine, 2,5-difluorobenzidine, 2,6-difluorobenzidine, 2,3,5-trifluorobenzidine, 2,3,6-trifluorobenzidine, 2,3,5,6-tetrafluorobenzidine, 2,2′-difluorobenzidine, 3,3′-difluorobenzidine, 2,3′-difluorobenzidine, 2,2′,3-trifluorobenzidine, 2,3,3′-trifluorobenzidine, 2,2′,5-trifluorobenzidine, 2,2′,6-trifluorobenzidine, 2,3′,5-trifluorobenzidine, 2,3′,6,-trifluorobenzidine, 2,2′,3,3′-tetrafluorobenzidine, 2,2′,5,5′-tetrafluorobenzidine, 2,2′,6,6′-tetrafluorobenzidine, 2,2′,3,3′,6,6′-hexafluorobenzidine, 2,2′,3,3′,5,5′,6,6′-octafluorobenzidine, 2-(trifluoromethyl)benzidine, 3-(trifluoromethyl)benzidine, 2,3-bis(trifluoromethyl)benzidine, 2,5-bis(trifluoromethyl)benzidine, 2,6-bis(trifluoromethyl)benzidine, 2,3,5-tris(trifluoromethyl)benzidine, 2,3,6-tris(trifluoromethyl)benzidine, 2,3,5,6-tetrakis(trifluoro)methyl)benzidine, 2,2′-bis(trifluoromethyl)benzidine, 3,3′-bis(trifluoromethyl)benzidine, 2,3′-bis(trifluoromethyl)benzidine, 2,2′,3-tris(trifluoromethyl)benzidine, 2,3,3′-tris(trifluoromethyl)benzidine, 2,2′,5-tris(trifluoromethyl)benzidine, 2,2′,6-tris(trifluoromethyl))benzidine, 2,3′,5-tris(trifluoromethyl)benzidine, 2,3′,6,-tris (trifluoromethyl)benzidine, 2,2′,3,3′-tetrakis(trifluoromethyl)benzidine, 2,2′,5,5′-tetrakis(trifluoromethyl)benzidine, and 2,2′,6,6′-tetrakis(trifluoromethyl)benzidine.

Among the fluoroalkyl-substituted benzidines, the fluoroalkyl group of the fluoroalkyl-substituted benzidine is preferably a perfluoroalkyl group from the viewpoint of achieving both solubility and transparency of the polyimide. The perfluoroalkyl group is preferably a trifluoromethyl group. In particular, from the viewpoint of the solubility of the polyimide in an organic solvent and the compatibility of the polyimide with the acryl-based resin, perfluoroalkyl-substituted benzidines having a perfluoroalkyl group at the 2-position of biphenyl are preferable, and 2,2′-bis(trifluoromethyl)benzidine (hereinafter, referred to as “TFMB”) is particularly preferable. When a trifluoromethyl group is present at each of 2- and 2′-positions of biphenyl, the π-electron density decreases due to the electron-attracting property of the trifluoromethyl group, and a bond between two benzene rings of biphenyl is twisted by steric hindrance of the trifluoromethyl group, leading to a decrease in planarity of the π-conjugate. Therefore, the absorption edge wavelength shifts to a short wave, so that coloring of the polyimide can be suppressed.

The content of the fluoroalkyl-substituted benzidine based on 100 mol % of the total amount of the diamine components is preferably 25 mol % or more, more preferably 30 mol % or more, still more preferably 40 mol % or more, particularly preferably 50 mol % or more, and may be 60 mol % or more, 70 mol % or more, 80 mol % or more, 85 mol % or more, or 90 mol % or more. A large content of the fluoroalkyl-substituted benzidine tends to lead to suppression of coloring of the film, and enhancement of mechanical strength in terms of pencil hardness, tensile modulus, and the like.

### (Alicyclic Diamine)

Examples of the diamine having an alicyclic structure include isophoronediamine, 1,2-cyclohexanediamine, 1,3-cyclohexanediamine, 1,4-cyclohexanediamine, 1,2-bis(aminomethyl)cyclohexane, 1,3-bis(aminomethyl)cyclohexane, 1,4-bis(aminomethyl)cyclohexane, bis(aminomethyl) norbornene, 4,4′-methylenebis(cyclohexylamine), bis(4-aminocyclohexyl) methane, 4,4′-methylenebis(2-methylcyclohexylamine), adamantane-1,3-diamine, 2,6-bis(aminomethyl) bicyclo[2.2.1]heptane, 2,5-bis(aminomethyl) bicyclo[2.2.1]heptane, and 1,1-bis(4-aminophenyl)cyclohexane.

The polyimide may contain a diamine other than the fluoroalkyl-substituted benzidine as the diamine component. Examples of the diamine component exhibiting compatibility with the acryl-based resin in the polyimide include diamines having a fluorene skeleton, diamines having a sulfone group, and fluorine-containing diamines other than the fluoroalkyl-substituted benzidine and the alicyclic diamine.

### (Diamine Having Fluorene Skeleton)

Examples of the diamine having a fluorene skeleton include 9,9-bis(4-aminophenyl)fluorene.

### (Sulfone Group-Containing Diamine)

Examples of the diamine having a sulfone group include 3,3′-diaminodiphenylsulfone, 3,4′-diaminodiphenylsulfone, 4,4′-diaminodiphenylsulfone, bis[4-(3-aminophenoxy)phenyl]sulfone, and bis[4-(4-aminophenoxy)phenyl]sulfone, 4,4′-bis[4-(4-amino-α,α-dimethylbenzyl)phenoxy]diphenylsulfone, and 4,4′-bis[4-(4-(aminophenoxy)phenoxy)diphenylsulfone. Among them, diaminodiphenylsulfones such as 3,3′-diaminodiphenylsulfone (3,3′-DDS) and 4,4′-diaminodiphenylsulfone (4,4′-DDS) are preferable.

For example, by using diaminodiphenylsulfone as the diamine in addition to the fluoroalkyl-substituted benzidine, the solvent-solubility and transparency of the polyimide resin may be improved. On the other hand, when the ratio of diaminodiphenylsulfone is large, compatibility with the acryl-based resin may be reduced. The content of diaminodiphenylsulfone based on 100 mol % of the total amount of diamines may be 1 to 40 mol %, 3 to 30 mol %, or 5 to 25 mol %.

### (Fluorine-Containing Diamine)

The fluorine-containing diamine preferably has a fluoroalkyl group. Examples of the diamine having a fluoroalkyl group (other than the fluoroalkyl-substituted benzidine) include diamines having an aromatic ring to which a fluoroalkyl group is bonded, such as 1,4-diamino-2-(trifluoromethyl)benzene, 1,4-diamino-2,3-bis(trifluoromethyl)benzene, 1,4-diamino-2,5-bis(trifluoromethyl)benzene, 1,4-diamino-2,6-bis(trifluoromethyl)benzene, 1,4-diamino-2,3,5-tris(trifluoromethyl)benzene, 1,4-diamino-2,3,5,6-tetrakis(trifluoromethyl)benzene; and diamines having a fluoroalkyl group not directly bonded to an aromatic ring, such as 2,2-bis(4-aminophenyl)hexafluoropropane, 2,2-bis(3-aminophenyl)hexafluoropropane, and 2,2-bis[4-(4-aminophenoxy)phenyl]hexafluoropropane.

Examples of the fluorine-containing diamine other than those described above include 2-fluorobenzidine, 3-fluorobenzidine, 2,3-difluorobenzidine, 2,5-difluorobenzidine, 2,6-difluorobenzidine, 2,3,5-trifluorobenzidine, 2,3,6-trifluorobenzidine, 2,3,5,6-tetrafluorobenzidine, 2,2′-difluorobenzidine, 3,3′-difluorobenzidine, 2,3′-difluorobenzidine, 2,2′3-trifluorobenzidine, 2,3,3′-trifluorobenzidine, 2,2′5-trifluorobenzidine, 2,2′6-trifluorobenzidine, 2,3′5-trifluorobenzidine, 2,3′6-trifluorobenzidine, 2,2′3,3′-tetrafluorobenzidine, 2,2′5,5′-tetrafluorobenzidine, 2,2′6,6′-tetrafluorobenzidine, 2,2′3,3′6,6′-hexafluorobenzidine, 2,2′3,3′5,5′6,6′-octafluorobenzidine, 1,4-diamino-2-fluorobenzene, 1,4-diamino-2,3-difluorobenzene, 1,4-diamino-2,5-difluorobenzene, 1,4-diamino-2,6-difluorobenzene, 1,4-diamino-2,3,5-trifluorobenzene, 1,4-diamino-2,3,5,6-tetrafluorobenzene, and 2,2′-dimethylbenzidine.

### (Diamine Having Amide Bond)

As the diamine component of the polyimide, a diamine having an amide bond may also be used. For example, an amide produced by bonding a diamine to carboxy groups at both ends of a dicarboxylic acid is represented by general formula (IV).

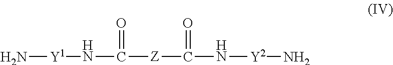

In the general formula (IV), Y¹ and Y² are diamine residues, and Z is a dicarboxylic acid residue. The general formula (IV) shows a structure in which one dicarboxylic acid and two diamines are condensed, but two dicarboxylic acids and three diamines may be condensed, or three or more dicarboxylic acids and four or more diamines may be condensed.

A polyimide containing a diamine having an amide structure represented by the general formula (IV) as the diamine component contains an amide bond in addition to an imide bond, and thus may be referred to as “polyamideimide.” In the preparation of the polyamideimide, a diamine having an amide bond is prepared in advance, and this may be used as a diamine; or a dicarboxylic acid or a derivative thereof is used as a monomer component in addition to the diamine and the tetracarboxylic dianhydride, and the diamine and the dicarboxylic acid (derivative) may be reacted at the time of polymerization to form an amide bond.

Examples of the dicarboxylic acid include aliphatic dicarboxylic acids such as adipic acid, suberic acid, azelaic acid, sebacic acid, and dodecanedioic acid; aromatic dicarboxylic acids such as terephthalic acid, isophthalic acid, 2-chloroterephthalic acid, 2-methylterephthalic acid, 5-methylisophthalic acid, 2,6-naphthalenedicarboxylic acid, 4,4′-oxybisbenzoic acid, biphenyl-4,4′-dicarboxylic acid, and 2-fluoroterephthalic acid; alicyclic dicarboxylic acids such as 1,4-cyclohexanedicarboxylic acid, 1,3-cyclohexanedicarboxylic acid, 1,2-hexahydroterephthalic acid, hexahydroisophthalic acid, cyclohexanedicarboxylic acid, and 1,3-cyclopentanedicarboxylic acid; and heterocyclic dicarboxylic acids such as 2,5-thiophene dicarboxylic acid and 2,5-furandicarboxylic acid. In the preparation of the compound containing a condensed structure of a diamine and a dicarboxylic acid, a dicarboxylic acid derivative such as dicarboxylic acid dichloride or dicarboxylic anhydride may be used instead of the dicarboxylic acid.

The amide structure-containing diamine represented by the general formula (IV) is composed of one dicarboxylic acid (derivative) and two diamines, but in the calculation of the molar ratio of diamines, the compound represented by the general formula (IV) is calculated as one diamine. For example, a compound in which an amino group of fluoroalkyl-substituted benzidine is condensed with each carboxy group at both ends of a dicarboxylic acid to form an amide bond includes two fluoroalkyl-substituted benzidines, but in the calculation of the molar ratio, the compound is calculated as one diamine (fluoroalkyl-substituted benzidine).

Specific examples of the diamine containing a condensed structure of a fluoroalkyl-substituted benzidine and a dicarboxylic acid include a condensate of TFMB and a dicarboxylic acid. The dicarboxylic acid is particularly preferably terephthalic acid and/or isophthalic acid. For example, a diamine in which TFMB is condensed at both ends of terephthalic acid has a structure of the following formula (4).

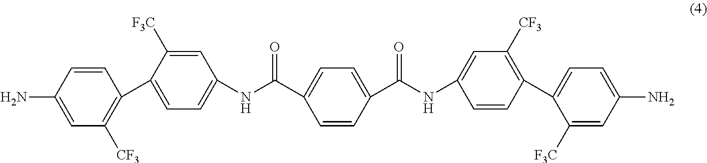 [SMILES: Nc1ccc(-c2ccc(NC(=O)c3ccc(C(=O)Nc4ccc(-c5ccc(N)cc5C(F)(F)F)c(C(F)(F)F)c4)cc3)cc2C(F)(F)F)c(C(F)(F)F)c1]

### (Other Diamines)

Examples of diamines other than those described above include aromatic diamines such as p-phenylenediamine, m-phenylenediamine, o-phenylenediamine, p-xylenediamine, m-xylenediamine, o-xylenediamine, 3,3′-diaminodiphenyl ether, 3,4′-diaminodiphenyl ether, 4,4′-diaminodiphenyl ether, 3,3′-diaminodiphenyl sulfide, 3,4′-diaminodiphenyl sulfide, 4,4′-diaminodiphenyl sulfide, 3,3′-diaminobenzophenone, 4,4′-diaminobenzophenone, 3,4′-diaminobenzophenone, 3,3′-diaminodiphenylmethane, 4,4′-diaminodiphenylmethane, 3,4′-diaminodiphenylmethane, 2,2-di(3-aminophenyl)propane, 2,2-di(4-aminophenyl)propane, 2-(3-aminophenyl)-2-(4-aminophenyl)propane, 1,1-di(3-aminophenyl)-1-phenylethane, 1,1-di(4-aminophenyl)-1-phenylethane, 1-(3-aminophenyl)-1-(4-aminophenyl)-1-phenylethane, 1,3-bis(3-aminophenoxy)benzene, 1,3-bis(4-aminophenoxy)benzene, 1,4-bis(3-aminophenoxy)benzene, 1,4-bis(4-aminophenoxy)benzene, 1,3-bis(3-aminobenzoyl)benzene, 1,3-bis(4-aminobenzoyl)benzene, 1,4-bis(3-aminobenzoyl)benzene, 1,4-bis(4-aminobenzoyl)benzene, 1,3-bis(3-amino-α,α-dimethylbenzyl)benzene, 1,3-bis(4-amino-α,α-dimethylbenzyl)benzene, 1,4-bis(3-amino-α,α-dimethylbenzyl)benzene, 1,4-bis(4-amino-α,α-dimethylbenzyl)benzene, 2,6-bis(3-aminophenoxy)benzonitrile, 2,6-bis(3-aminophenoxy)pyridine, 4,4′-bis(3-aminophenoxy)biphenyl, 4,4′-bis(4-aminophenoxy)biphenyl, bis[4-(3-aminophenoxy)phenyl]ketone, bis[4-(4-aminophenoxy)phenyl]ketone, bis[4-(3-aminophenoxy)phenyl]sulfide, bis[4-(4-aminophenoxy)phenyl]sulfide, bis[4-(3-aminophenoxy)phenyl]ether, bis[4-(4-aminophenoxy)phenyl]ether, 2,2-bis[4-(3-aminophenoxy)phenyl]ether, 2,2-bis[4-(4-aminophenoxy)phenyl]propane, 1,3-bis[4-(3-aminophenoxy)benzoyl]benzene, 1,3-bis[4-(4-aminophenoxy)benzoyl]benzene, 1,4-bis[4-(3-aminophenoxy)benzoyl]benzene, 1,4-bis[4-(4-aminophenoxy)benzoyl]benzene, 1,3-bis[4-(3-aminophenoxy)-α,α-dimethylbenzyl]benzene, 1,3-bis[4-(4-aminophenoxy)-α,α-dimethylbenzyl]benzene, 1,4-bis[4-(3-aminophenoxy)-α,α-dimethylbenzyl]benzene, 1,4-bis[4-(4-aminophenoxy)-α,α-dimethylbenzyl]benzene, 4,4′-bis[4-(4-aminophenoxy)benzoyl]diphenyl ether, 4,4′-bis[4-(4-amino-α,α-dimethylbenzyl)phenoxy]benzophenone, 3,3′-diamino-4,4′-diphenoxybenzophenone, 3,3′-diamino-4,4′-dibiphenoxybenzophenone, 3,3′-diamino-4-phenoxybenzophenone, 3,3′-diamino-4-biphenoxybenzophenone, 6,6′-bis(3-aminophenoxy)-3,3,3′3′-tetramethyl-1,1′-spirobiindane, and 6,6′-bis(4-aminophenoxy)-3,3,3′3′-tetramethyl-1,1′-spirobiindane.

As the diamine, chain diamines can also be used such as bis(aminomethyl)ether, bis(2-aminoethyl)ether, bis(3-aminopropyl)ether, bis(2-aminomethoxy)ethyl]ether, bis[2-(2-aminoethoxy)ethyl]ether, bis[2-(3-aminoprotoxy)ethyl]ether, 1,2-bis(aminomethoxy)ethane, 1,2-bis(2-aminoethoxy)ethane, 1,2-bis[2-(aminomethoxy)ethoxy]ethane, 1,2-bis[2-(2-aminoethoxy)ethoxy]ethane, ethylene glycol bis(3-aminopropyl)ether, diethylene glycol bis(3-aminopropyl)ether, triethylene glycol bis(3-aminopropyl)ether, ethylenediamine, 1,3-diaminopropane, 1,4-diaminobutane, 1,5-diaminopentane, 1,6-diaminohexane, 1,7-diaminoheptane, 1,8-diaminooctane, 1,9-diaminononane, 1,10-diaminodecane, 1,11-diaminoundecane, 1,12-diaminododecane, 1,3-bis(3-aminopropyl)tetramethyldisiloxane, 1,3-bis(4-aminobutyl)tetramethyldisiloxane, α,ω-bis(3-aminopropyl)polydimethylsiloxane, and α,ω-bis(3-aminobutyl)polydimethylsiloxane.

### <Acid Dianhydride>

The acid dianhydride component of the polyimide is not particularly limited, but the polyimide preferably contains at least one of a fluorine-containing aromatic tetracarboxylic dianhydride and an alicyclic tetracarboxylic dianhydride as the acid dianhydride component from the viewpoint of enhancing compatibility with the acryl-based resin.

### (Fluorine-Containing Aromatic Tetracarboxylic Dianhydride)

Examples of the fluorine-containing aromatic tetracarboxylic dianhydride include 4,4′-(hexafluoroisopropylidene)diphthalic anhydride, 2,2-bis[4-(3,4-dicarboxyphenoxy)phenyl]hexafluoropropane dianhydride, 1,4-difluoropyromellitic dianhydride, 1,4-bis(trifluoromethyl)pyromellitic dianhydride, 4-trifluoromethylpyromellitic dianhydride, 3,6-di[3′,5′-bis(trifluoromethyl)phenyl]pyromellitic dianhydride, and 1-(3′,5′-bis(trifluoromethyl)phenyl)pyromellitic dianhydride. Among them, 4,4′-(hexafluoroisopropylidene)diphthalic anhydride (6FDA) is particularly preferable from the viewpoint of achieving both transparency and mechanical strength of the polyimide.

### (Alicyclic Tetracarboxylic Dianhydride)

The alicyclic tetracarboxylic dianhydride is only required to have at least one alicyclic structure, and may have both an alicyclic ring and an aromatic ring in one molecule. The alicyclic ring may be polycyclic, or may have a spiro structure.

Examples of the alicyclic tetracarboxylic dianhydride include 1,2,3,4-cyclobutanetetracarboxylic dianhydride, 1,2,3,4-cyclopentanetetracarboxylic dianhydride, 1,3-dimethylcyclobutane-1,2,3,4-tetracarboxylic dianhydride, 1,2,3,4-tetramethyl-1,2,3,4-cyclobutanetetracarboxylic dianhydride, 1,2,4,5-cyclohexanetetracarboxylic dianhydride, 1,2,3,4-butanetetracarboxylic dianhydride, meso-butane-1,2,3,4-tetracarboxylic dianhydride, 1,1′-bicyclohexane-3,3′,4,4′ tetracarboxylic-3,4:3′,4′-dianhydride, norbornane-2-spiro-a-cyclopentanone-α′-spiro-2″-norbornane-5,5″,6,6″-tetracarboxylic dianhydride, 2,2′-binorbornane-5,5′,6,6′ tetracarboxylic dianhydride, 3-(carboxymethyl)-1,2,4-cyclopentanetricarboxylic 1,4:2,3-dianhydride, bicyclo[2.2.2]octa-7-ene-2,3,5,6-tetracarboxylic dianhydride, 4-(2,5-dioxotetrahydrofuran-3-yl)-1, 2,3,4-tetrahydronaphthalene-1,2-dicarboxylic anhydride, cyclohexane-1,4-diylbis(methylene)bis(1,3-dioxo-1,3-dihydroisobenzofuran-5-carboxylate), 5-(2,5-dioxotetrahydrofuryl)-3-methyl-3-cyclohexene-1,2-dicarboxylic anhydride, 5,5′-[cyclohexylidenebis(4,1-phenyleneoxy)]bis-1,3-isobenzofurandione, 5-isobenzofurancarboxylic acid, 1,3-dihydro-1,3-dioxo-,5,5′-[1,4-cyclohexanediylbis(methylene)]ester, bicyclo[2.2.1]heptane-2,3,5,6-tetracarboxylic dianhydride, bicyclo[2.2.2]octane-2,3,5,6-tetracarboxylic dianhydride, 3,5,6-tricarboxynorbornane-2-acetic 2,3:5,6-dianhydride, decahydro-1,4,5,8-dimethanonaphthalene-2,3,6,7-tetracarboxylic dianhydride, tricyclo[6.4.0.0 (2,7)]dodecane-1,8:2,7-tetracarboxylic dianhydride, octahydro-1H,3H,8H,10H-biphenyleno[4a,4b-c:8a,8b-c′]difuran-1,3,8,10-tetrone, ethylene glycolbis(hydrogenated trimellitic anhydride)ester, and decahydro[2]benzopyrano[6,5,4,-def][2]benzopyrano-1,3,6,8-tetrone.

The alicyclic tetracarboxylic dianhydride preferably does not contain an aromatic ring and has an acid anhydride group bonded to an alicyclic ring from the viewpoint of the transparency of the polyimide and compatibility with the acryl-based resin. Among the alicyclic tetracarboxylic dianhydrides, 1,2,3,4-cyclobutanetetracarboxylic dianhydride (CBDA), 1,2,3,4-cyclopentanetetracarboxylic dianhydride (CPDA), 1,2,4,5-cyclohexanetetracarboxylic dianhydride (H-PMDA), or 1,1′-bicyclohexane-3,3′,4,4′-tetracarboxylic-3,4:3′,4′-dianhydride (H-BPDA) is preferable from the viewpoint of the transparency and mechanical strength of the polyimide, and CBDA is particularly preferable.

### (Other Acid Dianhydrides)

The polyimide may contain, as the acid dianhydride component, an acid dianhydride other than the fluorine-containing aromatic acid dianhydride and the alicyclic acid dianhydride. When the polyimide contains, as the acid dianhydride component, a fluorine-free aromatic tetracarboxylic dianhydride in addition to the fluorine-containing aromatic acid dianhydride and/or the alicyclic acid dianhydride, compatibility between the polyimide resin and the acryl-based resin may be improved, and the mechanical strength of the film may be improved.

Examples of the fluorine-free aromatic tetracarboxylic dianhydride include acid dianhydrides in which two acid anhydride groups are bonded to one benzene ring, such as pyromellitic dianhydride and mellophanic dianhydride; acid dianhydrides in which two acid anhydride groups are bonded to one condensed polycyclic ring, such as 2,3,6,7-naphthalenetetracarboxylic 2,3:6,7-dianhydride, naphthalene-1,4,5,8-tetracarboxylic dianhydride, and terphenyltetracarboxylic dianhydride; and acid dianhydrides in which an acid anhydride group is bonded to different aromatic rings, such as bis(trimellitic anhydride)ester, 3,3′,4,4′-biphenyltetracarboxylic dianhydride, 3,3′,4,4′-benzophenonetetracarboxylic dianhydride, 4,4′-oxydiphthalic anhydride, 3,4′-oxydiphthalic anhydride, 3,3′,4,4′-diphenylsulfonetetracarboxylic dianhydride, 4,4′-(4,4′-isopropylidenediphenoxy)diphthalic anhydride, 5,5′-dimethylmethylenebis(phthalic anhydride), 9,9-bis(3,4-dicarboxyphenyl)fluorene dianhydride, 11,11-dimethyl-1H-difuro[3,4-b:3′,4′-i]xanthene-1,3,7,9 (11H)-tetrone, 1,4-bis(3,4-dicarboxyphenoxy)benzene dianhydride, 4-(2,5-dioxotetrahydrofuran-3-yl)-1,2,3,4-tetrahydronaphthalene-1,2-dicarboxylic dianhydride, ethylene glycol bis(trimellitic anhydride), N,N′-(9H-fluoren-9-ylidenedi-4,1-phenylene)bis[1,3-dihydro-1,3-dioxo-5-isobenzofurancarboxamide], N,N′-[[2,2,2-trifluoro-1-(trifluoromethyl)ethylidene]bis(6-hydroxy-3,1-phenylene)]bis[1,3-dihydro-1,3-dioxo-5-isobenzofurancarboxamide], and 2,2-bis(4-hydroxyphenyl)propane dibenzoate-3,3′,4,4′-tetracarboxylic dianhydride.

Among them, pyromellitic dianhydride (PMDA), mellophanic dianhydride (MPDA), 3,3′4,4′-biphenyltetracarboxylic dianhydride (BPDA), 4,4′-oxydiphthalic anhydride (ODPA), 3,3′4,4′-benzophenonetetracarboxylic dianhydride (BTDA), 4′-(4,4′-isopropylidenediphenoxy)diphthalic anhydride (BPADA), 9,9-bis(3,4-dicarboxyphenyl)fluorene dianhydride (BPAF), and bis(trimellitic anhydride)ester are preferable as the fluorine-free tetracarboxylic dianhydride from the viewpoint of the transparency and solubility of the polyimide and compatibility with the acryl-based resin.

The bis(trimellitic anhydride)ester is represented by the following general formula (1).

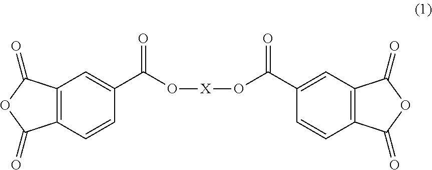

X in general formula (1) is an arbitrary divalent organic group, and a carboxy group and a carbon atom of X are bonded to each other at both ends of X. The carbon atom bonded to the carboxy group may form a ring structure. Specific examples of the divalent organic group X include the following (A) to (K).

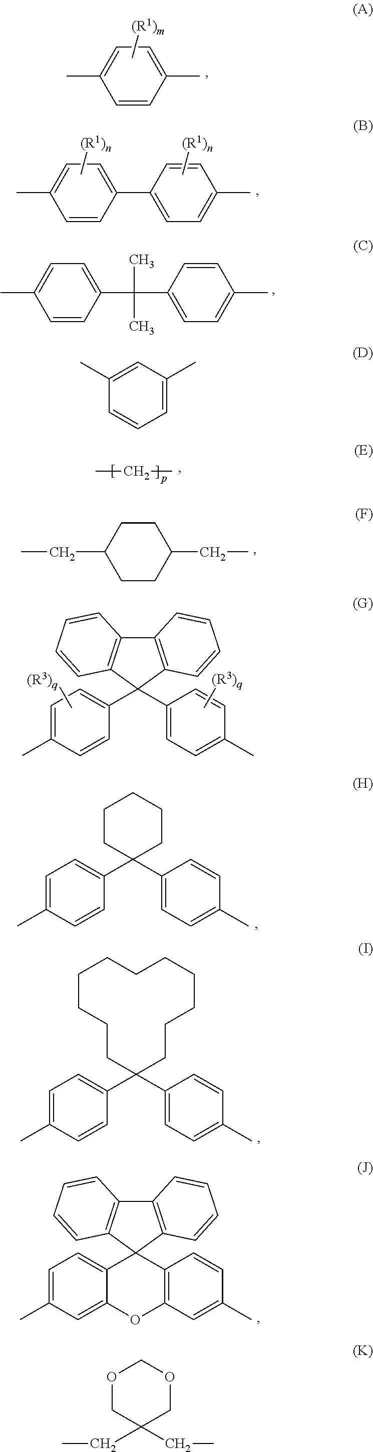

R¹ in formula (A) is an alkyl group having 1 to 20 carbon atoms, and m is an integer of 0 to 4. The group of formula (A) is a group obtained by removing two hydroxy groups from a hydroquinone derivative optionally having a substituent on a benzene ring. Examples of the hydroquinone having a substituent on a benzene ring include tert-butylhydroquinone, 2,5-di-tert-butylhydroquinone and 2,5-di-tert-amylhydroquinone. In the general formula (1), when X is (A) and m is 0 (that is, there is no substituent on the benzene ring), bis(trimellitic anhydride)ester is p-phenylenebis(trimellitate anhydride) (abbreviation: TAHQ).

In formula (B), R² is an alkyl group having 1 to 20 carbon atoms, and n is an integer of 0 to 4. The group of formula (B) is a group obtained by removing two hydroxy groups from biphenol optionally having a substituent on a benzene ring. Examples of the biphenol derivative having a substituent on a benzene ring include 2,2′-dimethylbiphenyl-4,4′-diol, 3,3′-dimethylbiphenyl-4,4′-diol, 3,3′,5,5′-tetramethylbiphenyl-4,4′-diol and 2,2′,3,3′,5,5′-hexamethylbiphenyl-4,4′-diol.

The group of formula (C) is a group obtained by removing two hydroxy groups from 4,4′-isopropylidenediphenol (bisphenol A). The group of formula (D) is a group obtained by removing two hydroxy groups from resorcinol.

In formula (E), p is an integer of 1 to 10. The group of formula (E) is a group obtained by removing two hydroxy groups from a linear diol having 1 to 10 carbon atoms. Examples of the linear diol having 1 to 10 carbon atoms include ethylene glycol, and 1,4-butanediol.

The group of formula (F) is a group obtained by removing two hydroxy groups from 1,4-cyclohexanedimethanol.

In formula (G), R³ is an alkyl group having 1 to 20 carbon atoms, and q is an integer of 0 to 4. The group of formula (G) is a group obtained by removing two hydroxy groups from biphenol fluorene optionally having a substituent on a benzene ring having a phenolic hydroxy group. Examples of the bisphenol fluorene derivative having a substituent on a benzene ring having a phenolic hydroxy group include biscresol fluorene.

The bis(trimellitic anhydride)ester is preferably an aromatic ester. Among the above groups (A) to (K), groups (A), (B), (C), (D), (G), (H) and (I) are preferable as X. Among them, the groups (A) to (D) are preferable, and the group (B) having a biphenyl backbone is particularly preferable. When X is a group of general formula (B), X is preferably 2,2′,3,3′,5,5′-hexamethylbiphenyl-4,4′-diyl of the following formula (B1) from the viewpoint of the solubility of the polyimide in an organic solvent.

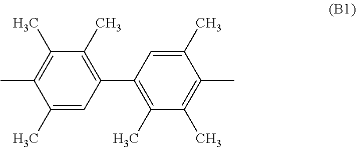

The acid dianhydride in which X is a group of formula (B1) in general formula (1) is bis(1,3-dioxo-1,3-dihydroisobenzofuran-5-carboxylic acid)-2,2′,3,3′,5,5′-hexamethylbiphenyl-4,4′ diyl (abbreviation: TAHMBP) of the following formula (3).

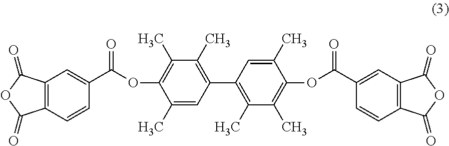

Examples of tetracarboxylic dianhydrides other than those described above include ethylenetetracarboxylic dianhydride and butanetetracarboxylic dianhydride.

From the viewpoint of enhancing the compatibility between the polyimide resin and the acryl-based resin, the total content of the fluorine-containing aromatic tetracarboxylic dianhydride and the alicyclic tetracarboxylic dianhydride based on 100 mol % of the total amount of acid dianhydride components is preferably 15 mol % or more, more preferably 20 mol % or more, still more preferably 25 mol % or more, and may be 30 mol % or more, 40 mol % or more, 50 mol % or more, 60 mol % or more, 70 mol % or more, 80 mol % or more, or 90 mol % or more.

When the polyimide contains, as the acid dianhydride component, a fluorine-containing aromatic tetracarboxylic dianhydride and does not contain an alicyclic tetracarboxylic dianhydride, the content of the fluorine-containing aromatic tetracarboxylic dianhydride based on 100 mol % of the total amount of acid dianhydride components is preferably 30 mol % or more, more preferably 35 mol % or more, still more preferably 40 mol % or more, and may be 50 mol % or more, 60 mol % or more, 70 mol % or more, 80 mol % or more, or 90 mol % or more. The whole of the acid dianhydride components may be the fluorine-containing aromatic tetracarboxylic dianhydride.

When the polyimide contains, as the acid dianhydride component, an alicyclic tetracarboxylic dianhydride and does not contain a fluorine-containing aromatic tetracarboxylic dianhydride, the content of the alicyclic tetracarboxylic dianhydride based on 100 mol % of the total amount of the acid dianhydride components is preferably 15 mol % or more, more preferably 20 mol % or more, and may be 25 mol % or more or 30 mol % or more.

When the polyimide contains, as the acid dianhydride component, a fluorine-containing aromatic tetracarboxylic dianhydride and an alicyclic tetracarboxylic dianhydride, the total content of the fluorine-containing aromatic tetracarboxylic dianhydride and the alicyclic tetracarboxylic dianhydride based on 100 mol % of the total amount of the acid dianhydride components is preferably 20 mol % or more, more preferably 25 mol % or more, still more preferably 30 mol % or more, and may be 35 mol % or more, 40 mol % or more, 50 mol % or more, 60 mol % or more, 70 mol % or more, 80 mol % or more, or 90 mol % or more.

The content of the alicyclic tetracarboxylic dianhydride based on 100 mol % of the total amount of the acid dianhydride components is preferably 80 mol % or less, more preferably 70 mol % or less, still more preferably 65 mol % or less, and may be 60 mol % or less, 55 mol % or less, or 50 mol % or less from the viewpoint of ensuring the solubility of the polyimide resin in an organic solvent regardless of whether or not the polyimide contains the fluorine-containing aromatic tetracarboxylic dianhydride as the acid dianhydride component. In order for the acryl-based resin and the polyimide resin to be compatible with each other even in a low-boiling-point non-amide-based solvent (for example, a halogen-based solvent such as methylene chloride), the content of the alicyclic tetracarboxylic dianhydride based on the total amount of the acid dianhydride components of the polyimide is preferably 45 mol % or less, more preferably 40 mol % or less, and may be 35 mol % or less.

When the polyimide contains an alicyclic tetracarboxylic dianhydride as the acid dianhydride component, in order for the polyimide resin and the acryl-based resin to be compatible with each other in the organic solvent, the polyimide preferably contains, as the acid dianhydride component, a fluorine-containing aromatic tetracarboxylic dianhydride and/or a fluorine-free aromatic tetracarboxylic dianhydride in addition to the alicyclic tetracarboxylic dianhydride. As described above, the alicyclic tetracarboxylic dianhydride is preferably CBDA, the fluorine-containing aromatic tetracarboxylic dianhydride is preferably 6FDA, and the fluorine-free aromatic tetracarboxylic dianhydride is preferably PMDA, MPDA, BPDA, ODPA, BTDA, BPADA, BPAF, and bis(trimellitic anhydride)ester. The bis(trimellitic anhydride)ester is preferably TAHQ and TAHMBP, and particularly preferably TAHMBP.

When the polyimide contains a fluorine-containing aromatic tetracarboxylic dianhydride as the acid dianhydride component, the polyimide resin and the acryl-based resin are compatible in the organic solvent even if the whole of the acid dianhydrides is the fluorine-containing aromatic tetracarboxylic dianhydride. In order for the acryl-based resin and the polyimide resin to be compatible with each other even in a low-boiling-point non-amide-based solvent (for example, a halogen-based solvent such as methylene chloride), the content of the fluorine-containing tetracarboxylic dianhydride based on the total amount of the acid dianhydride components of the polyimide is preferably 90 mol % or less, more preferably 85 mol % or less, and may be 80 mol % or less, 70 mol % or less, 65 mol % or less, or 60 mol % or less.

When the polyimide contains, as the acid dianhydride component, a fluorine-containing aromatic tetracarboxylic dianhydride and does not contain an alicyclic tetracarboxylic dianhydride, in order for the acryl-based resin and the polyimide resin to be compatible with each other in the low-boiling-point non-amide-based solvent, the content of the fluorine-containing aromatic tetracarboxylic dianhydride based on 100 mol % of the total amount of the acid dianhydride components is preferably 30 to 90 mol %, more preferably 35 to 80 mol %, and still more preferably 40 to 75 mol %. From the same viewpoint, the content of the fluorine-free aromatic tetracarboxylic dianhydride based on 100 mol % of the total amount of the acid dianhydride components is preferably 10 to 70 mol %, more preferably 20 to 65 mol %, and still more preferably 25 to 60 mol %. As described above, the fluorine-containing aromatic tetracarboxylic dianhydride is preferably 6FDA, and the fluorine-free aromatic tetracarboxylic dianhydride is preferably PMDA, MPDA, BPDA, ODPA, BTDA, BPADA, BPAF, and bis(trimellitic anhydride)ester. The bis(trimellitic anhydride)ester is preferably TAHQ and TAHMBP, and particularly preferably TAHMBP.

### (Preparation of Polyimide)

A polyamic acid as a polyimide precursor is obtained by a reaction between an acid dianhydride and a diamine, and a polyimide is obtained by cyclodehydration (imidization) of the polyamic acid. As described above, adjustment of the composition of the polyimide, i.e., the types and ratios of the acid dianhydride and the diamine, allows the polyimide to have transparency and solubility in an organic solvent and exhibit compatibility with an acryl-based resin.

The method for preparing a polyamic acid solution is not particularly limited, and any known method can be applied. For example, the acid dianhydride and the diamine are dissolved in an organic solvent in substantially equimolar amounts (molar ratio=95:100 to 105:100), and the solution is stirred to obtain a polyamic acid solution. The concentration of the polyamic acid solution is typically 5 to 35 wt %, preferably 10 to 30 wt %. When the concentration is in this range, the polyamic acid obtained by polymerization has an appropriate molecular weight, and the polyamic acid solution has an appropriate viscosity.

In the polymerization of the polyamic acid, a method is preferable in which an acid dianhydride is added to a diamine for suppressing ring opening of the acid dianhydride. When a plurality kinds of diamine and a plurality kinds of acid dianhydride are added, they may be added at one time, or may be added in a plurality of additions. By adjusting the order of adding the monomers, various physical properties of the polyimide can be controlled.

The organic solvent used for polymerization of the polyamic acid is not particularly limited as long as it does not react with a diamine and an acid dianhydride and can dissolve the polyamic acid. Examples of the organic solvent include urea-based solvents such as methylurea and N,N-dimethylethylurea; sulfoxide or sulfone-based solvents such as dimethyl sulfoxide, diphenylsulfone and tetramethylsulfone; amide-based solvents such as N,N-dimethyacetamide (DMAc), N,N-dimethylformamide (DMF), N,N′-diethylacetamide, N-methyl-2-pyrrolidone (NMP), γ-butyrolactone and hexamethylphosphoric triamide; alkyl halide-based solvents such as chloroform and methylene chloride; aromatic hydrocarbon-based solvents such as benzene and toluene; and ether-based solvents such as tetrahydrofuran, 1,3-dioxolane, 1,4-dioxane, dimethyl ether, diethyl ether and p-cresol methyl ether. These solvents are normally used alone, or if necessary, two or more thereof are used in combination as appropriate. From the viewpoint of the solubility and polymerization reactivity of the polyamic acid, DMAc, DMF, NMP, and the like are preferably used.

A polyimide can be obtained by cyclodehydration of the polyamic acid. Examples of the method for preparing a polyimide from a polyamic acid solution include a method in which a dehydrating agent, an imidization catalyst and the like are added to a polyamic acid solution to advance imidization in the solution. The polyamic acid solution may be heated to accelerate the progress of imidization. By mixing a poor solvent with a solution containing a polyimide generated by imidization of the polyamic acid, a polyimide resin is precipitated as a solid. By isolating the polyimide resin as a solid substance, impurities generated during synthesis of the polyamic acid, and the residual dehydration agent and the imidization catalyst and the like can be washed and removed with the poor solvent, so that it is possible to prevent coloring of the polyimide and an increase in yellowness. By isolating the polyimide resin as a solid, a solvent suitable for forming a film, such as a low-boiling-point solvent, can be applied in preparation of a solution for producing a film.

The molecular weight (weight average molecular weight in terms of polyethylene oxide which is measured by gel filtration chromatography (GPC)) of the polyimide is preferably 10,000 to 300,000, more preferably 20,000 to 250,000, still more preferably 40,000 to 200,000. An excessively small molecular weight may result in insufficient strength of the film. An excessively large molecular weight may result in poor compatibility with the acryl-based resin.

The polyimide resin is preferably soluble in non-amide-based solvents such as ketone-based solvents and halogenated alkyl-based solvents. The phrase “the polyimide resin exhibits solubility in a solvent” means that the polyimide resin is dissolved at a concentration of 5 wt % or more. In an embodiment, the polyimide has solubility in methylene chloride. Methylene chloride has a low boiling point, so that it is easy to remove the residual solvent during production of the film. Therefore, the use of a polyimide resin soluble in methylene chloride can be expected to improve productivity of the film.

From the viewpoint of the heat stability and light stability of the resin composition and the film, it is preferable that the polyimide has low reactivity. The acid value of the polyimide is preferably 0.4 mmol/g or less, more preferably 0.3 mmol/g or less, still more preferably 0.2 mmol/g or less. The acid value of the polyimide may be 0.1 mmol/g or less, 0.05 mmol/g or less, or 0.03 mmol/g or less. From the viewpoint of reducing the acid value, it is preferable that the polyimide has a high imidization ratio. A small acid value tends to lead to enhancement of the stability of the polyimide, and improvement of compatibility with the acryl-based resin.

### <Acryl-Based Resin>

Examples of the acryl-based resin include poly(meth)acrylic acid esters such as polymethyl methacrylate, methyl methacrylate-(meth)acrylic acid copolymers, methyl methacrylate-(meth)acrylic acid ester copolymers, methyl methacrylate-acrylic acid ester-(meth)acrylic acid copolymers, and methyl (meth)acrylate-styrene copolymers. The acryl-based resin may have a glutarimide structural unit or a lactone ring structural unit introduced by modification. The tacticity of the polymer is not particularly limited, and may be any of an isotactic type, a syndiotactic type and an atactic type.

From the viewpoint of transparency, compatibility with polyimide, and mechanical strength of a film, it is preferable that the acryl-based resin has methyl methacrylate as a main structural unit. The amount of methyl methacrylate based on the amount of all monomer components in the acryl-based resin is preferably 60 wt % or more, and may be 70 wt % or more, 80 wt % or more, 85 wt % or more, 90 wt % or more, or 95 wt % or more. The acryl-based resin may be a homopolymer of methyl methacrylate.

In the acryl-based resin, a glutarimide structural unit or a lactone ring structural unit may be introduced as described above. Such a modified polymer is preferably one obtained by introducing a glutarimide structure or a lactone ring structure into an acrylic polymer whose methyl methacrylate content is in the above-described range. That is, in the acryl-based resin modified by introduction of a glutarimide structure or a lactone ring structure, the total amount of methyl methacrylate and modified structures of methyl methacrylate is preferably 60 wt % or more, and may be 70 wt % or more, 80 wt % or more, 85 wt % or more, 90 wt % or more, or 95 wt % or more. The modified polymer may be one obtained by introducing a glutarimide structure or a lactone ring structure into a homopolymer of methyl methacrylate.

Introduction of a glutarimide structure or a lactone ring structure into an acryl-based polymer such as methyl methacrylate tends to lead to improvement of the glass transition temperature of the acryl-based resin. The glutarimide-modified acryl-based resin contains an imide structure, and therefore may have improved compatibility with the polyimide.

The acryl-based resin having a glutarimide structure is obtained by, for example, heating and melting a polymethyl methacrylate resin and performing treatment with an imidizing agent as described in Japanese Patent Laid-open Publication No. 2010-261025. When the acryl-based polymer has a glutarimide structure, the glutarimide content may be 3 wt % or more, 5 wt % or more, 10 wt % or more, 20 wt % or more, 30 wt % or more, or 50 wt % or more.

The glutarimide content is calculated by determining the ratio of introduction of the glutarimide structure (imidization ratio) from a 1H-NMR spectrum of the acryl-based resin and converting the imidization ratio to a weight basis. For example, in methyl methacrylate into which a glutarimide structure has been introduced, the imidization ratio Im=B/(A+B) is determined, where A is an area of a peak originating from O—CH₃ protons of methyl methacrylate (around 3.5 to 3.8 ppm) and B is an area of a peak originating from N—CH₃ protons of glutarimide (around 3.0 to 3.3 ppm).

From the viewpoint of the heat resistance of the film, the glass transition temperature of the acryl-based resin is preferably 90° C. or higher, more preferably 100° C. or higher, still more preferably 110° C. or higher, and may be 115° C. or higher, or 120° C. or higher.

From the viewpoint of solubility in an organic solvent, compatibility with the polyimide and film strength, the weight average molecular weight of the acryl-based resin (in terms of polystyrene) is preferably 5,000 to 500,000, more preferably 10,000 to 300,000, still more preferably 15,000 to 200,000.

From the viewpoint of the heat stability and light stability of the resin composition and the film, it is preferable that the content of reactive functional groups such as ethylenically unsaturated groups and carboxy groups in the acryl-based resin is small. The iodine value of the acryl-based resin is preferably 10.16 g/100 g (0.4 mmol/g) or less, more preferably 7.62 g/100 g (0.3 mmol/g) or less, still more preferably 5.08 g/100 g (0.2 mmol/g) or less. The iodine value of the acryl-based resin may be 2.54 g/100 g (0.1 mmol/g) or less, or 1.27 g/100 g (0.05 mmol/g) or less. The acid value of the acryl-based resin is preferably 0.4 mmol/g or less, more preferably 0.3 mmol/g or less, still more preferably 0.2 mmol/g or less. The acid value of the acryl-based resin may be 0.1 mmol/g or less, 0.05 mmol/g or less, or 0.03 mmol/g or less. A small acid value tends to lead to enhancement of the stability of the acryl-based resin, and improvement of compatibility with the polyimide.

### [Resin Composition]

The polyimide resin and the acryl-based resin are blended to prepare a resin composition. Since the polyimide resin and the acryl-based resin at an arbitrary ratio can be compatible with each other, the ratio between the polyimide resin and the acryl-based resin in the resin composition is not particularly limited. The blending ratio (weight ratio) of the polyimide resin to the acryl-based resin may be 98:2 to 2:98, 95:5 to 10:90, or 90:10 to 15:85. As the proportion of the polyimide resin is higher, the tensile modulus and pencil hardness of the film are higher, the mechanical strength is excellent, and improvement in the tensile modulus and bending resistance by stretching tends to be remarkable. As the proportion of the acryl-based resin is higher, the film is less colored, thus has higher transparency, and also has lower glass transition temperature, so that processability such as stretching of the film tends to be improved.

In order to sufficiently exhibit the effect of improving transparency and processability by mixing the polyimide resin with the acryl-based resin, the proportion of the acryl-based resin in the total of the polyimide resin and the acryl-based resin is preferably 10 wt % or more, and may be 15 wt % or more, 20 wt % or more, 25 wt % or more, 30 wt % or more, 35 wt % or more, 40 wt % or more, 45 wt % or more, 50 wt % or more, 60 wt % or more, or 70 wt % or more. On the other hand, from the viewpoint of obtaining a film having excellent mechanical strength, the proportion of the polyimide resin in the total of the polyimide resin and the acryl-based resin is preferably 10 wt % or more, more preferably 20 wt % or more, still more preferably 30 wt % or more, and may be 40 wt % or more, 50 wt % or more, 60 wt % or more, 65 wt % or more, 70 wt % or more, 75 wt % or more, or 80 wt % or more.

The polyimide is a polymer having a special molecular structure, and generally has low solubility in an organic solvent and is not compatible with other polymers. As described above, the polyimide containing specific diamine component and acid dianhydride component exhibits high solubility in an organic solvent and compatibility with the acryl-based resin.

It is preferable that a resin composition containing the polyimide resin and the acryl-based resin has a single glass transition temperature in differential scanning calorimetry (DSC) and/or dynamic mechanical analysis (DMA). When the resin composition has a single glass transition temperature, it can be considered that the polyimide resin and the acryl-based resin are completely compatible with each other. It is preferable that a film containing the polyimide resin and the acryl-based resin has a single glass transition temperature.

From the viewpoint of heat resistance, the glass transition temperature of the resin composition and the film is preferably 110° C. or higher, and may be 115° C. or higher, 120° C. or higher, 125° C. or higher, 130° C. or higher, 135° C. or higher, 140° C. or higher, 145° C. or higher, or 150° C. or higher. On the other hand, from the viewpoint of processability such as stretching, the glass transition temperature of the resin composition and the film is preferably lower than 250° C., and may be 240° C. or lower, 230° C. or lower, 220° C. or lower, or 210° C. or lower.

The resin composition may be one obtained by simply mixing a polyimide resin and an acryl-based resin precipitated as a solid content, or may be one obtained by kneading a polyimide resin and an acryl-based resin. When the polyimide solution is mixed with a poor solvent to precipitate the polyimide resin, an acryl-based resin may be mixed with the solution to precipitate a resin composition in which the polyimide and the acryl-based resin are mixed as a solid (powder).

The resin composition may be a mixed solution containing a polyimide resin and an acryl-based resin. The method for blending the resins is not particularly limited, and the resins may be mixed in a solid state, or may be mixed in a liquid to form a mixed solution. The polyimide solution and the acryl-based resin solution may be individually prepared, and mixed to prepare a mixed solution of the polyimide and the acryl-based resin.

The solvent of a solution containing the polyimide resin and the acryl-based resin is not particularly limited as long as it exhibits an ability to dissolve both the polyimide resin and the ester-based resin. Examples of the solvent include amide-based solvents such as N,N-dimethylformamide, N,N-dimethylacetamide, and N-methyl-2-pyrrolidone; ether-based solvents such as tetrahydrofuran and 1,4-dioxane; ketone-based solvents such as acetone, methyl ethyl ketone, methyl propyl ketone, methyl isopropyl ketone, methyl isobutyl ketone, diethyl ketone, cyclopentanone, cyclohexanone, and methyl cyclohexanone; and halogenated alkyl solvents such as chloroform, 1,2-dichloroethane, 1,1,2,2-tetrachloroethane, chlorobenzene, dichlorobenzene, and methylene chloride.

From the viewpoint of the solubility of the polyimide resin and the compatibility between the polyimide resin and the acryl-based resin in the solution, amide-based solvents are preferable. On the other hand, low-boiling-point non-amide-based solvents are preferable from the viewpoint of solvent removability in production of a formed a film, and ketone-based solvents and halogenated alkyl-based solvents are preferable because they are excellent in ability to dissolve a polyimide resin as well as an acryl-based resin, and have a low boiling point, so that it is easy to remove the residual solvent during production of a film.

For the purpose of, for example, improving the processability of the film and imparting various functions, an organic or inorganic low-molecular-weight compound, a high-molecular-weight compound (for example, epoxy resin) or the like may be blended in the resin composition (solution). The resin composition may contain a flame retardant, an ultraviolet absorber, a crosslinking agent, a dye, a pigment, a surfactant, a leveling agent, a plasticizer, fine particles, a sensitizer, and the like. The fine particles include organic fine particles such as those of polystyrene and polytetrafluoroethylene, and inorganic fine particles such as those of colloidal silica, carbon and layered silicate, and may have a porous or hollow structure. Fiber reinforcement materials include carbon fibers, glass fibers, and aramid fibers.

### [Film]

### <Film Formation>

A film containing a polyimide resin and an acryl-based resin can be produced by a known method such as a melting method or a solution method. As described above, the polyimide resin and the acryl-based resin may be mixed in advance, or may be mixed at the time of film formation. A compound obtained by kneading the polyimide resin and the acryl-based resin may be used.

A resin composition containing a polyimide resin and an acryl-based resin tends to have a melt viscosity lower than that of a polyimide resin alone, and is excellent in moldability in melt extrusion molding and the like. A solution of a resin composition containing a polyimide and an acryl-based resin tends to have a solution viscosity lower than that of a solution of a polyimide alone, which has the same solid concentration. Therefore, the solution is excellent in handling properties such as transportability, and has a high coating property, which is advantageous in suppression of unevenness in thickness of the film, and the like.

As described above, the method for forming the film may be either a melting method or a solution method, and a solution method is preferable from the viewpoint of producing a film excellent in transparency and uniformity. In the solution method, a solution containing the polyimide resin and the acryl-based resin is applied onto a support, and the solvent is removed by drying to obtain a film.

As a method for applying the resin solution onto the support, a known method using a bar coater, a comma coater or the like can be applied. As the support, a glass substrate, a metal substrate, a metal drum or a metal belt made of SUS or the like, a plastic film, or the like can be used. From the viewpoint of improving productivity, it is preferable to produce a film by a roll-to-roll process using an endless support such as a metal drum or a metal belt, a long plastic film or the like as a support. When a plastic film is used as the support, a material that is not soluble in a deposition dope solvent may be appropriately selected.

It is preferable to perform heating the solvent during drying. The heating temperature is not particularly limited as long as the solvent can be removed and coloring of the resulting film can be suppressed, and the temperature is appropriately set to room temperature to about 250° C., and is preferably 50° C. to 220° C. The heating temperature may be elevated stepwise. After drying proceeds to some extent, the resin film may be peeled off from the support and dried for enhancing the solvent removal efficiency. For accelerating the removal of the solvent, heating may be performed under reduced pressure.

### <Stretching>

A film immediately after film formation (in the case of the solution method, after drying a solvent) is an unstretched film, and generally has no refractive index anisotropy. By stretching the film in at least one direction, the in-plane refractive index anisotropy of the film tends to increase, and the mechanical strength of the film tends to be improved.

The film containing a polyimide resin and an acryl-based resin generally tends to have a large refractive index in the stretching direction. In a compatible system of the polyimide resin and the acryl-based resin, the tensile modulus in the stretching direction of the film increases, and the increase in the tensile modulus is remarkable when the stretching ratio is increased. By stretching the film, bending resistance in the stretching direction (bending resistance when a direction orthogonal to the stretching direction is a bending axis) tends to be improved.

In the direction orthogonal to the stretching direction, the tensile modulus tends to be smaller than that before stretching (unstretched film). However, the decrease in the tensile modulus in the orthogonal direction is slight as compared with the increase in the tensile modulus in the stretching direction. In addition, in the compatible system of the polyimide resin and the acryl-based resin, not only the bending resistance in the stretching direction is improved, but also the bending resistance in the direction orthogonal to the stretching direction tends to be improved by stretching the film.

The stretching conditions of the film are not particularly limited, and a method of stretching the film in the conveying direction between a pair of nip rolls having different peripheral speeds (free-end uniaxial stretching), a method of fixing both ends of the film in the width direction with pins or clips and stretching the film in the width direction (fixed-end uniaxial stretching), or the like can be employed.

The heating temperature during stretching is not particularly limited, and may be set, for example, within a range of about +40° C. of the glass transition temperature of the film. As the stretching temperature is lower, the refractive index anisotropy of the film tends to increase. In addition, as the stretching ratio increases, the refractive index anisotropy of the film tends to increase.

The stretching temperature is preferably lower than 250° C., more preferably 245° C. or lower, and may be 240° C. or lower, 230° C. or lower, 225° C. or lower, 220° C. or lower, 215° C. or lower, 210° C. or lower, 205° C. or lower, 200° C. or lower, 195° C. or lower, or 190° C. or lower from the viewpoint of suppressing coloring of the film due to heating during stretching and obtaining a film having high transparency (low yellowness). The compatible resin composition of the polyimide resin and the acryl-based resin has a glass transition temperature lower than that of the polyimide resin alone, and thus has good stretching processability even at a temperature lower than 250° C.

The stretching temperature is preferably 100° C. or higher, more preferably 110° C. or higher, and may be 120° C. or higher, 130° C. or higher, 140° C. or higher, 150° C. or higher, 160° C. or higher, 170° C. or higher, or 180° C. or higher from the viewpoint of suppressing the increase in the haze of the film due to stretching.

The stretching ratio may be set so that an index R (%): 100×(n₁−n₂)/n₂ of the in-plane refractive index anisotropy of the film after stretching is 1.0% or more. The stretching ratio is, for example, 1 to 300%, and may be 5% or more, 10% or more, 30% or more, 50% or more, 70% or more, 90% or more, or 120% or more, or may be 250% or less, 200% or less, or 150% or less. The stretching ratio (%) is represented by 100×(L₁−L₀)/L₀, where L₀ is the length (original length) of the film before stretching in the stretching direction, and L₁ is the length of the film after stretching in the stretching direction.

### [Properties of Film]

The thickness of the film is not particularly limited, and may be appropriately set according to a use purpose. The thickness of the film (after stretched) is, for example, 5 to 300 μm. From the viewpoint of achieving both self-supporting properties and flexibility and obtaining a film having high transparency, the thickness of the film is preferably 20 μm to 100 μm, and may be 30 μm to 90 μm, 40 μm to 85 μm, or 50 μm to 80 μm. The thickness of the film which is used as a cover film for a display is preferably 30 μm or more, more preferably 40 μm or more, and may be 50 μm or more.

As described above, the stretched film has refractive index anisotropy, and a difference (n₁−n₂) between a refractive index n₁ in the first direction in which the in-plane refractive index of the film is maximum and a refractive index n₂ in the second direction orthogonal to the first direction is 1.0% or more of n₂. That is, the index R=100×(n₁−n₂)/n₂ of the in-plane refractive index anisotropy of the film is 1.0 or more. The direction (first direction) in which the in-plane refractive index is maximum is determined using a retardation meter. The slow axis direction determined by retardation measurement is the first direction. The refractive index n₁ in the first direction and the refractive index n₂ in the second direction are values measured by a prism coupler method.

As the stretching ratio is larger and the orientation of molecules in the stretching direction is larger, the index R of the refractive index anisotropy tends to be larger and the tensile modulus in the stretching direction tends to be larger. R may be 1.2% or more, 1.5% or more, 2.0% or more, or 3.0% or more.

The total light transmittance of the film is preferably 85% or more, more preferably 86% or more, still more preferably 87% or more, and may be 88% or more, 89% or more, 90% or more, or 91% or more. The haze of the film is preferably 10% or less, more preferably 5% or less, still more preferably 4% or less, and may be 3.5% or less, 3% or less, 2% or less, or 1% or less. In the compatible system of the polyimide resin and the acryl-based resin, high transparency is maintained even when stretching is performed so that R is 1.0%, and thus a transparent film having a high total light transmittance and a low haze is obtained.

The yellowness index (YI) of the film is preferably 5.0 or less, more preferably 4.0 or less, still more preferably 3.0 or less, and may be 2.0 or less, 1.5 or less, or 1.0 or less. By mixing the polyimide resin with the acryl-based resin, a film is obtained which is less colored and has smaller YI as compared to a case where the polyimide resin is used alone. In addition, the compatible resin composition of the polyimide resin and the acryl-based resin has a lower glass transition temperature than that of the polyimide resin alone. Therefore, a film can be stretched at a low temperature, and coloring of the film due to heating during stretching is suppressed, so that a stretched film having a small YI can be obtained.

The tensile modulus in the stretching direction (direction in which polymer chains are oriented) is preferably 4.0 GPa or more, more preferably 4.2 GPa or more, and may be 4.5 GPa or more or 5.0 GPa or more from the viewpoint of the strength. In general, since the stretching direction is identical to the first direction or the second direction, the tensile modulus of at least one of the first direction and the second direction is preferably in the above range. In a mixed system of the polyimide resin and the acryl-based resin, since the stretching direction is generally identical to the first direction, the tensile modulus in the first direction is preferably in the above range.

An unstretched film made of a resin composition containing a polyimide resin and an acryl-based resin has a tensile modulus smaller than that of a film made of a polyimide resin alone. However, when a film made of the compatible system of the polyimide resin and the acryl-based resin is stretched, the tensile modulus in the stretching direction is remarkably increased. Therefore, it is possible to realize a high tensile modulus comparable to or higher than that of the film made of a polyimide resin alone.

The tensile modulus in the direction orthogonal to the stretching direction (for example, in the second direction) tends to decrease as the film is stretched. However, the decrease in the tensile modulus in the orthogonal direction is slight as compared with the increase in the tensile modulus in the stretching direction. The tensile modulus in the direction orthogonal to the stretching direction is preferably 2.7 GPa or more, more preferably 2.8 GPa or more, and may be 3.0 GPa or more.

The pencil hardness of the film is preferably equal to or greater than F, and may be equal to or greater than H, or equal to or greater than 2H. In the compatible system of the polyimide resin and the acryl-based resin, the pencil hardness hardly decreases even if the proportion of the acryl-based resin is increased, and thus the pencil hardness does not change greatly even if stretching is performed. Therefore, it is possible to obtain a film which is less colored and excellent in transparency while the excellent mechanical strength characteristic of a polyimide is not reduced.

When a dynamic bending test involving repeatedly bending a film under conditions of a bending radius of 1.0 mm, a bending angle of 180°, and a bending speed of 1 time/second with a direction orthogonal to the stretching direction of the film as the bending axis is performed, the endurable number of cycles (the number of bending times until the film is cracked or broken) is preferably 100,000 times or more, and may be 150,000 times or more or 200,000 times or more. Since the bending resistance in the stretching direction is improved by stretching the film, the endurable number of cycles when the dynamic bending test is performed with a direction orthogonal to the stretching direction as the bending axis is significantly larger than the endurable number of cycles of an unstretched film.

As described above, the tensile modulus in the direction orthogonal to the stretching direction tends to be smaller than that of the unstretched film. Meanwhile, the endurable number of cycles in the direction orthogonal to the stretching direction (the endurable number of cycles in the dynamic bending test in which the stretching direction is set as the bending axis) tends to be larger than the endurable number of cycles of the unstretched film. The endurable number of cycles when the dynamic bending test is performed with the stretching direction as the bending axis may be 10,000 times or more, 30,000 times or more, 50,000 times or more, or 100,000 times or more.

### [Application of Film]

The above-described film has high transparency and excellent mechanical strength, and thus is suitably used for cover films disposed on a surface on the viewing side of image display panels, transparent substrates for displays, transparent substrates for touch panels, substrates for solar cells, and the like. When the film is put into practical use, a surface of the film may be provided with an antistatic layer, an easily bondable layer, a hard coat layer, an antireflection layer and the like.

The above-described film has high bending resistance, and thus can be particularly suitably used as cover films disposed on a surface on the viewing side of curved screen displays or foldable displays. For example, a cover film of a foldable image display device (foldable display) is repeatedly bent along the bending axis at the same position. Such a cover film is required to have high mechanical strength in the direction perpendicular to the bending axis, and a large endurable number of cycles. When the film is disposed so that the stretching direction of the film is perpendicular to the bending axis, breaks and cracks of the cover film hardly occur even if the cover film is repeatedly bent at the same position, and therefore it is possible to provide a device having excellent bending resistance.

### EXAMPLES

Hereinafter, embodiments of the present invention will be described in further detail by showing examples. The present invention is not limited to examples below.

### [Polyimide Resin Production Examples]

Dimethylformamide was added into a separable flask, and stirred in a nitrogen atmosphere. Diamine and an acid dianhydride were added at a ratio (%) as shown in Tables 1 and 2, and the mixture was reacted by stirring in a nitrogen atmosphere for 5 to 10 hours to obtain a polyamic acid solution having a solid content concentration of 18 wt %.

To 100 g of the polyamic acid solution, 6.0 g of pyridine as an imidization catalyst was added, and completely dispersed, 8 g of acetic anhydride was then added, and the mixture was stirred at 90° C. for 3 hours. The solution was cooled to room temperature, and 100 g of 2-propyl alcohol (hereinafter, referred to as “IPA”) was then added dropwise at a rate of 2 to 3 drops/sec while the solution was stirred, thereby precipitating a polyimide. Further, 150 g of IPA was added, the mixture was stirred for about 30 minutes, and suction filtration was performed with a Kiriyama funnel. The obtained solid was washed with IPA, and then dried in a vacuum oven set at 120° C. for 12 hours to obtain a polyimide resin.

### [Film Production Examples]

### Comparative Examples 1 to 3

The polyimide (PI) having a composition of 6FDA/CBDA//TFMB=70/30//100 obtained in the production example and a commercially available polymethyl methacrylate resin (“PARAPET HM1000” manufactured by KURARAY CO., LTD., glass transition temperature: 120° C., acid value: 0.0 mmol/g, hereinafter referred to as “acrylic resin 1”) were dissolved in methylene chloride (DCM) at a weight ratio as shown in Table 1, thereby preparing a solution having a resin content of 11 wt %. This solution was applied onto an alkali-free glass plate, and dried by heating at 60° C. for 15 minutes, 90° C. for 15 minutes, 120° C. for 15 minutes, 150° C. for 15 minutes, 180° C. for 15 minutes, and 200° C. for 15 minutes in an air atmosphere to produce films having a thickness shown in Table 1.

The film of Comparative Example 1 was subjected to differential scanning calorimetry (DSC) using a differential scanning calorimeter (“DSC7000X” manufactured by Hitachi High-Tech Corporation) under conditions of a temperature raising rate of 10° C./min and a temperature range of 50° C. to 270° C. in a nitrogen atmosphere. As a result, the inflection point (glass transition point) of the DSC curve was confirmed at 178° C., and no inflection point was confirmed in the vicinity of 120° C. which is the glass transition temperature of the acrylic resin 1. From this result, it can be said that in the resin composition of Comparative Example 1, the polyimide resin and the acryl-based resin are completely compatible with each other. Also in the films of Comparative Examples 2 and 3, the DSC curve in the range of 50 to 270° C. showed only one inflection point (glass transition point). The glass transition temperature of Comparative Example 2 was 148° C., and the glass transition temperature of Comparative Example 3 was 221° C.

### Comparative Examples 4 to 8

Films were prepared in the same manner as in Comparative Example 1 except that each of the following acrylic resins 2 to 4 was used instead of the acrylic resin 1, and the mixing ratio of the polyimide and the acryl-based resin was changed as shown in Table 1. DSC measurement of each of the films of Comparative Example 4, Comparative Example 5, Comparative Example 6, Comparative Example 7 and Comparative Example 8 was performed. As a result, the DSC curve showed only one glass transition point in the range of 50 to 270° C., and the glass transition temperatures of respective Comparative Examples were 172° C., 177° C., 188° C., 183° C., and 196° C.
Acrylic resin 2: “PARAPET HR-G” manufactured by KURARAY CO., LTD., glass transition temperature: 116° C., acid value: 0.0 mmol/g
Acrylic resin 3: Copolymer of methyl methacrylate/methyl acrylate (monomer ratio: 87/13) (“PARAPET G-1000” manufactured by KURARAY CO., LTD.), glass transition temperature: 109° C., acid value: 0.0 mmol/g
Acrylic resin 4: Syndiotactic polymethyl methacrylate (“PARAPET SP-01” manufactured by KURARAY CO., LTD.), glass transition temperature: 130° C., acid value: 0.0 mmol/g
Acrylic resin 5: Acrylic resin having a glutarimide ring and prepared as described in “Acryl-Based Resin Production Example” in Japanese Patent Laid-open Publication No. 2018-70710 (glutarimide content: 4 wt %, glass transition temperature: 125° C., acid value: 0.4 mmol/g
Acrylic resin 6: Acrylic resin having a glutarimide ring and prepared as described in “Acryl-Based Resin Production Example” in Japanese Patent Laid-open Publication No. 2018-70710 (glutarimide content: 70 wt %, glass transition temperature: 146° C., acid value: 0.1 mmol/g

### Examples 1 to 8 and 11 to 13

Films containing a polyimide resin and an acryl-based resin were produced in the same manner as in Comparative Examples 1 to 4 and 6 to 8, and each film was cut into a rectangle. The short sides (both ends in the longitudinal direction) of the cut rectangle film were chucked, and the distance between chucks was changed in an oven at the temperature shown in Table 1 to perform free-end uniaxial stretching at the stretching ratio shown in Table 1.

### Examples 9 and 10

Films containing a polyimide resin and an acryl-based resin were produced in the same manner as in Comparative Example 5, and each film was cut into a rectangle. The short sides (both ends in the longitudinal direction) of the cut rectangle film was chucked. Then, in a state in which both ends of the long side of the film were held and fixed with clips, fixed-end uniaxial stretching was performed at the stretching ratio shown in Table 1 while changing a distance between chucks in an oven at the temperature shown in Table 1.

### Reference Example 1

A film having a thickness of about 50 μm was produced under the same conditions as Comparative Example 1 except that a methylene chloride solution of the acrylic resin 1 was prepared, and the heating conditions during drying were changed to 60° C. for 30 minutes, 80° C. for 30 minutes, 100° C. for 30 minutes and 110° C. for 30 minutes.

### Reference Examples 2 and 3

Acrylic films were produced in the same manner as in Reference Example 1, and each film was subjected to free-end uniaxial stretching under the conditions shown in Table 1.

### Comparative Examples 9 to 14

Films were prepared in the same manner as in Comparative Example 1 except that the composition of the polyimide was changed as shown in Table 3, and N,N-dimethylformamide (DMF) was used as the solvent in place of methylene chloride (DCM) in Comparative Examples 12 to 14. DSC measurement of each of the films of Comparative Example 9, Comparative Example 11, Comparative Example 12, Comparative Example 13 and Comparative Example 14 was performed. As a result, the DSC curve showed only one glass transition point in the range of 50 to 270° C., and the glass transition temperatures of respective Comparative Examples were 183° C., 185° C., 159° C., 170° C. and 196° C.

### Examples 14 to 19

Films containing a polyimide resin and an acryl-based resin were produced in the same manner as in Comparative Examples 9 to 14, and each film was subjected to free-end uniaxial stretching under the conditions shown in Table 3.

### Reference Examples 4 and 5

In Reference Examples 4 and 5, a methylene chloride solution of a polyimide resin was prepared, and a film having a thickness of about 50 μm was produced under the same conditions as Comparative Example 1.

### [Evaluation]

### <Haze and Total Light Transmittance>

The film was cut to a 3 cm square, and the haze and the total light transmittance (TT) were measured in accordance with JIS K 7136 and JIS K 7361-1 using a haze meter “HZ-V3” manufactured by Suga Test Instruments Co., Ltd.

### <Yellowness Index>

The film was cut to a 3 cm square, and the yellowness index (YI) was measured in accordance with JIS K 7373 using a spectrophotometer “SC-P” manufactured by Suga Test Instruments Co., Ltd.

### <Determination of First Direction>

Retardation was measured at a wavelength of 589 nm by a parallel Nicole rotation method, using a retardation measuring device “KOBRA” manufactured by Oji Scientific Instruments. The direction of the orientation axis (slow axis direction), that is, a direction in which the in-plane refractive index was maximum was defined as the first direction. A direction orthogonal to the first direction in the film plane (fast axis direction) was defined as the second direction.

### <Refractive Index>

The film was cut into a 3 cm square, and the refractive index n₁ in the first direction and the refractive index n₂ in the second direction of the film were measured by a prism coupler (“2010/M” manufactured by Metricon Corporation). Then, the index R (%): 100×(n₁−n₂)/n₂ of the in-plane refractive index anisotropy was calculated from n₁ and n₂.

### <Tensile Modulus>

The film was cut into a strip shape having a width of 10 mm with the first direction as the long side, and this was allowed to stand at 23° C./55% RH for 1 day to adjust the humidity thereof. Then, a tensile test was performed on the film with the first direction as the tensile direction under the following conditions using “AUTOGRAPH AGS-X” manufactured by Shimadzu Corporation to measure the tensile modulus in the first direction. For the stretched films of Examples 1 to 19 and Reference Examples 2 and 3, a sample cut into a strip shape with the second direction as the long side was used, a tensile test was performed on each film with the second direction as a tensile direction to measure the tensile modulus in the second direction.
Distance between chucks: 100 mm
Tensile speed: 20.0 mm/min
Measurement temperature: 23° C.

### <Pencil Hardness>

According to JIS K5600-5-4 “Pencil Scratch Test,” the pencil hardness of the film was measured with the first direction as the scratching direction (pencil moving direction). For the stretched films of Examples 1 to 19 and Reference Examples 2 and 3, the pencil hardness when the second direction was the scratching direction was also measured.

### <Dynamic Bending Test>

The film was cut into a strip shape of 20 mm×150 mm with the first direction as the long side. The short sides of this sample were attached to a U-shape folding test jig (“DMX-FS” manufactured by Yuasa System Co., Ltd.). Then, under an environment of a temperature of 23° C. and a relative humidity of 55%, a repetition bending test was performed under the conditions of a bending radius of 1.0 mm, a bending angle of 180°, and a bending speed of 1 time/second with the second direction of the film as the bending axis by a desktop endurance test machine (“DMLHB” manufactured by Yuasa System Co., Ltd.) to determine the endurable number of cycles. Specifically, the presence or absence of cracks or breakage of the film was checked every 1,000 times of bending, and the maximum number of times of bending at which cracks or breakage did not occur was defined as the endurable number of cycles. When cracks or breakage occurs in 1000 times of the bending test, the presence or absence of cracks or breakage was checked every 100 times.

For the stretched films of Examples 1 to 19 and Reference Examples 2 and 3, a sample cut into a strip shape with the second direction as the long side was used, and the endurable number of cycles was also measured for the case where the first direction was the bending axis. The endurable number of cycles when the test was performed by using a sample with the first direction as the long side and setting the second direction as the bending axis was defined as the endurable number of cycles in the first direction. The endurable number of cycles when the test was performed using a sample with the second direction as the long side and setting the first direction as the bending axis was defined as the endurable number of cycles in the second direction.

<Observation with Transmission Electron Microscope (TEM)>

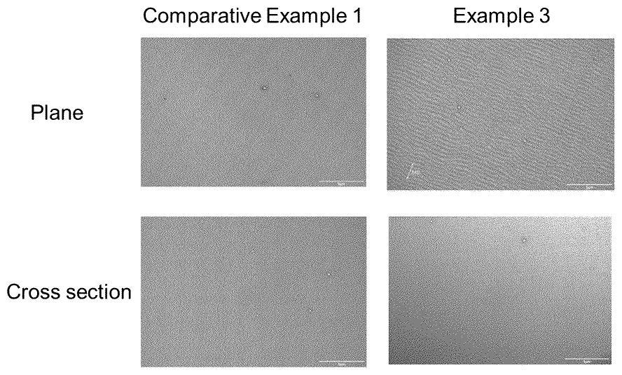

The planes (film surfaces) and cross-sections of the films of Comparative Example 1 and Example 3 were observed with a transmission electron microscope (magnification: 10,000 times). A TEM image is shown in FIG. 1.

### [Evaluation Results]

For Examples 1 to 13, Comparative Examples 1 to 8, and Reference Examples 1 to 3, the composition of the resin (composition of polyimide, type of acryl-based resin, and mixing ratio), the film preparation conditions (type of solvent and stretching conditions), the thickness, haze, total light transmittance (TT), and yellowness index of the film are shown in Table 1, and the evaluation results of the tensile modulus, the pencil hardness, the endurable number of cycles in the dynamic bending test, and the refractive index are shown in Table 2. For Examples 14 to 19, Comparative Examples 9 to 14, and Reference Examples 4 and 5, the composition of the resin, the preparation conditions of the film, and the evaluation results are shown in Tables 3 and 4. Those not evaluated for the tensile modulus, the pencil hardness, and the dynamic bending test were described as “ND” in the tables.

In Tables 1 to 4, the compounds are represented by the following abbreviations.

### <Acid Dianhydride>

6FDA: 4,4′-(hexafluoroisopropylidene)diphthalic anhydride
CBDA: 1,2,3,4-Cyclobutanetetracarboxylic dianhydride
TAHMBP: Bis(1,3-dioxo-1,3-dihydroisobenzofuran-5-carboxylic acid)-2,2′,3,3′,5,5′-hexamethylbiphenyl-4,4′-diyl
TAHQ: p-phenylenebis(trimellitate anhydride)
BPDA: 3,3′,4,4′-Biphenyltetracarboxylic dianhydride
ODPA: 4,4′-Oxydiphthalic anhydride
BPADA: 4,4′-(4,4′-Isopropylidenediphenoxy)diphthalic anhydride
PMDA: Pyromellitic dianhydride

### <Diamine>

TFMB: 2,2′-Bis(trifluoromethyl)benzidine
DDS: 3,3′-Diaminodiphenylsulfone

TABLE 1

| | Resin composition | | | | | | | | | | | |
|---|---|---|---|---|---|---|---|---|---|---|---|---|
| | Polyimide composition (mol %) | | | Type of | PI/acryl | | Stretching | | | | | |
| | Acid dianhydride | | Diamine | acrylic | (weight | | Temperature | Stretching | Thickness | Haze | TT | |
| | 6FDA | CBDA | TFMB | resin | ratio) | Solvent | (° C.) | ratio (%) | (μm) | (%) | (%) | YI |
| Comparative | 70 | 30 | 100 | 1 | 50/50 | DCM | — | | 58 | 0.3 | 91.7 | 0.5 |
| Example 1 | | | | | | | | | | | | |
| Example 1 | | | | | | | 210 | 30 | 50 | 0.2 | 91.5 | 0.6 |
| Example 2 | | | | | | | 210 | 50 | 42 | 0.4 | 91.4 | 0.7 |
| Example 3 | | | | | | | 210 | 70 | 42 | 0.3 | 91.5 | 0.6 |
| Example 4 | | | | | | | 210 | 90 | 37 | 0.2 | 91.5 | 0.6 |
| Example 5 | | | | | | | 215 | 120 | 42 | 0.3 | 91.2 | 0.9 |
| Comparative | | | | 1 | 30/70 | DCM | — | | 56 | 0.2 | 92.1 | 0.4 |
| Example 2 | | | | | | | | | | | | |
| Example 6 | | | | | | | 185 | 70 | 64 | 0.2 | 92.0 | 0.5 |
| Comparative | | | | 1 | 70/30 | DCM | — | | 48 | 0.2 | 91.2 | 0.7 |
| Example 3 | | | | | | | | | | | | |
| Example 7 | | | | | | | 245 | 70 | 50 | 0.2 | 91.0 | 0.7 |
| Reference | — | | | 1 | 0/100 | DCM | — | | 51 | 0.3 | 92.6 | 0.2 |
| Example 1 | | | | | | | | | | | | |
| Reference | | | | | | | 145 | 30 | 48 | 0.3 | 92.6 | 0.2 |
| Example 2 | | | | | | | | | | | | |
| Reference | | | | | | | 155 | 70 | 53 | 0.6 | 92.5 | 0.2 |
| Example 3 | | | | | | | | | | | | |
| Comparative | 70 | 30 | 100 | 2 | 50/50 | DCM | — | | 60 | 0.3 | 91.7 | 0.6 |
| Example 4 | | | | | | | | | | | | |
| Example 8 | | | | | | | 215 | 70 | 64 | 0.2 | 91.6 | 0.6 |
| Comparative | | | | 3 | 55/45 | DCM | — | | 48 | 0.9 | 91.6 | 0.9 |
| Example 5 | | | | | | | | | | | | |
| Example 9 | | | | | | | 195 | 50 | 48 | 0.2 | 91.4 | 0.7 |
| Example 10 | | | | | | | 195 | 70 | 49 | 1.1 | 91.4 | 0.8 |
| Comparative | | | | 4 | 50/50 | DCM | — | | 63 | 0.4 | 91.6 | 0.6 |
| Example 6 | | | | | | | | | | | | |
| Example 11 | | | | | | | 201 | 90 | 45 | 0.2 | 91.5 | 0.6 |
| Comparative | | | | 5 | 50/50 | DCM | — | | 64 | 0.3 | 91.5 | 0.6 |
| Example 7 | | | | | | | | | | | | |
| Example 12 | | | | | | | 200 | 90 | 35 | 0.2 | 91.4 | 0.6 |
| Comparative | | | | 6 | 55/45 | DCM | — | | 52 | 0.3 | 91.3 | 0.7 |
| Example 8 | | | | | | | | | | | | |
| Example 13 | | | | | | | 215 | 70 | 44 | 0.2 | 91.0 | 0.8 |

TABLE 2

| | Resin composition | | | | Stretching conditions | | Tensile modulus | |
|---|---|---|---|---|---|---|---|---|
| | | Type of | PI/acryl | | | Stretching | (GPa) | |
| | Polyimide | acrylic | (weight | | Temperature | ratio | First | Second |
| | composition | resin | ratio) | Solvent | (° C.) | (%) | direction | direction |
| Comparative | 6FDA/CBDA//TFMB = | 1 | 50/50 | DCM | — | | 3.9 | ND |
| Example 1 | 70/30//100 | | | | | | | |
| Example 1 | | | | | 210 | 30 | 4.5 | 3.9 |
| Example 2 | | | | | 210 | 50 | 5.2 | 3.8 |
| Example 3 | | | | | 210 | 70 | 6.3 | 3.4 |
| Example 4 | | | | | 210 | 90 | 7.4 | 3.5 |
| Example 5 | | | | | 215 | 120 | 8.8 | 3.5 |
| Comparative | | 1 | 30/70 | DCM | — | | 3.4 | ND |
| Example 2 | | | | | | | | |
| Example 6 | | | | | 185 | 70 | 4.2 | 3.4 |
| Comparative | | 1 | 70/30 | DCM | — | | 4.2 | ND |
| Example 3 | | | | | | | | |
| Example 7 | | | | | 245 | 70 | 7.4 | 3.7 |
| Reference | — | 1 | 0/100 | DCM | — | | 2.6 | ND |
| Example 1 | | | | | | | | |
| Reference | | | | | 145 | 30 | 2.7 | 2.6 |
| Example 2 | | | | | | | | |
| Reference | | | | | 155 | 70 | 2.6 | 2.6 |
| Example 3 | | | | | | | | |
| Comparative | 6FDA/CBDA//TFMB = | 2 | 50/50 | DCM | — | | 4.0 | ND |
| Example 4 | 70/30//100 | | | | | | | |
| Example 8 | | | | | 215 | 70 | 5.6 | 3.3 |
| Comparative | | 3 | 55/45 | DCM | — | | 4.0 | ND |
| Example 5 | | | | | | | | |
| Example 9 | | | | | 195 | 50 | 5.0 | 3.6 |
| Example 10 | | | | | 195 | 70 | 5.6 | 3.5 |
| Comparative | | 4 | 50/50 | DCM | — | | 3.9 | ND |
| Example 6 | | | | | | | | |
| Example 11 | | | | | 201 | 90 | 7.7 | 3.0 |
| Comparative | | 5 | 50/50 | DCM | — | | 4.0 | ND |
| Example 7 | | | | | | | | |
| Example 12 | | | | | 200 | 90 | 7.6 | 3.2 |
| Comparative | | 6 | 55/45 | DCM | — | | 4.0 | ND |
| Example 8 | | | | | | | | |
| Example 13 | | | | | 215 | 70 | 6.8 | 3.2 |

| | | | Dynamic bending | | | | |
|---|---|---|---|---|---|---|---|
| | Pencil hardness | | (1000 times) | | Refractive index | | |
| | First | Second | First | Second | | | R |
| | direction | direction | direction | direction | n₁ | n₂ | (%) |
| Comparative | 2H | ND | 13 | ND | 1.5290 | 1.5290 | 0.00 |
| Example 1 | | | | | | | |
| Example 1 | 2H | H | 108 | 150 | 1.5433 | 1.5199 | 1.54 |
| Example 2 | 2H | 2H | 200 | 400 | 1.5508 | 1.5158 | 2.31 |
| Example 3 | H | 2H | 570 | 473 | 1.5522 | 1.5162 | 2.37 |
| Example 4 | 2H | H | 620 | 35 | 1.5600 | 1.5111 | 3.24 |
| Example 5 | H | H | 254 | 100 | 1.5653 | 1.5069 | 3.88 |
| Comparative | HB | ND | 5 | ND | 1.5118 | 1.5114 | 0.03 |
| Example 2 | | | | | | | |
| Example 6 | HB | 2H | 265 | 100 | 1.5223 | 1.5045 | 1.18 |
| Comparative | 2H | ND | 25 | ND | 1.5434 | 1.5433 | 0.01 |
| Example 3 | | | | | | | |
| Example 7 | 2H | 2H | 100 | 100 | 1.5766 | 1.5261 | 3.31 |
| Reference | HB | ND | 1 | ND | 1.4932 | 1.4931 | 0.00 |
| Example 1 | | | | | | | |
| Reference | HB | B | 0.6 | 0.5 | 1.4930 | 1.4930 | 0.00 |
| Example 2 | | | | | | | |
| Reference | HB | HB | 0.3 | 0.5 | 1.4930 | 1.4930 | 0.00 |
| Example 3 | | | | | | | |
| Comparative | 2H | ND | 14 | ND | 1.5283 | 1.5280 | 0.02 |
| Example 4 | | | | | | | |
| Example 8 | 3H | 4H | 100 | 100 | 1.5517 | 1.5113 | 2.67 |
| Comparative | 2H | ND | 80 | ND | 1.5312 | 1.5312 | 0.00 |
| Example 5 | | | | | | | |
| Example 9 | 3H | 3H | 330 | 150 | 1.5442 | 1.5240 | 1.33 |
| Example 10 | 3H | 3H | 550 | 150 | 1.5502 | 1.5204 | 1.96 |
| Comparative | 3H | ND | 10 | ND | 1.5267 | 1.5266 | 0.01 |
| Example 6 | | | | | | | |
| Example 11 | 2H | 3H | 300 | 300 | 1.5555 | 1.5107 | 2.97 |
| Comparative | 3H | ND | 10 | ND | 1.5308 | 1.5306 | 0.02 |
| Example 7 | | | | | | | |
| Example 12 | 2H | H | 300 | 300 | 1.5571 | 1.5168 | 2.66 |
| Comparative | 3H | ND | 10 | ND | 1.5459 | 1.5457 | 0.01 |
| Example 8 | | | | | | | |
| Example 13 | 3H | H | 300 | 300 | 1.5775 | 1.5255 | 3.40 |

TABLE 3

| | Resin composition | | | | | | | | | | |
|---|---|---|---|---|---|---|---|---|---|---|---|
| | Polyimide composition (mol %) | | | | | | | | | | Type of |
| | Acid dianhydride | | | | | | | | Diamine | | acrylic |
| | 6FDA | CBDA | TAHMBP | TAHQ | BPDA | ODPA | BPADA | PMDA | TFMB | DDS | resin |
| Comparative | 85 | 15 | — | — | — | — | — | — | 100 | — | 1 |
| Example 9 | | | | | | | | | | | |
| Example 14 | | | | | | | | | | | |
| Comparative | — | 30 | 50 | — | — | 20 | — | — | 90 | 10 | 1 |
| Example 10 | | | | | | | | | | | |
| Example 15 | | | | | | | | | | | |
| Reference | | | | | | | | | | | — |
| Example 4 | | | | | | | | | | | |
| Comparative | 40 | — | — | — | — | — | 20 | 40 | 80 | 20 | 1 |
| Example 11 | | | | | | | | | | | |
| Example 16 | | | | | | | | | | | |
| Reference | | | | | | | | | | | — |
| Example 5 | | | | | | | | | | | |
| Comparative | 100 | — | — | — | — | — | — | — | 100 | — | 1 |
| Example 12 | | | | | | | | | | | |
| Example 17 | | | | | | | | | | | |
| Comparative | 60 | — | — | — | 40 | — | — | — | 100 | — | 1 |
| Example 13 | | | | | | | | | | | |
| Example 18 | | | | | | | | | | | |
| Comparative | 50 | — | — | 25 | 25 | — | — | — | 70 | 30 | 1 |
| Example 14 | | | | | | | | | | | |
| Example 19 | | | | | | | | | | | |

| | Resin composition | | Stretching | | | | | |
|---|---|---|---|---|---|---|---|---|
| | PI/acryl | | | Stretching | | | | |
| | (weight | | Temperature | ratio | Thickness | Haze | TT | |
| | ratio) | Solvent | (° C.) | (%) | (μm) | (%) | (%) | YI |
| Comparative | 50/50 | DCM | — | | 53 | 0.3 | 91.7 | 0.6 |
| Example 9 | | | | | | | | |
| Example 14 | | | 215 | 70 | 51 | 0.4 | 91.0 | 0.7 |
| Comparative | 50/50 | DCM | — | | 51 | 1.2 | 90.8 | 1.1 |
| Example 10 | | | | | | | | |
| Example 15 | | | 215 | 70 | 48 | 0.5 | 91.0 | 0.8 |
| Reference | 100/0 | DCM | — | | 52 | 0.5 | 89.3 | 2.3 |
| Example 4 | | | | | | | | |
| Comparative | 50/50 | DCM | — | | 53 | 0.3 | 91.1 | 2.3 |
| Example 11 | | | | | | | | |
| Example 16 | | | 200 | 70 | 47 | 0.4 | 90.9 | 2.4 |
| Reference | 100/0 | DCM | — | | 51 | 0.3 | 89.5 | 7.5 |
| Example 5 | | | | | | | | |
| Comparative | 50/50 | DMF | — | | 52 | 0.3 | 91.7 | 0.7 |
| Example 12 | | | | | | | | |
| Example 17 | | | 180 | 70 | 48 | 0.3 | 91.5 | 0.6 |
| Comparative | 50/50 | DMF | — | | 56 | 0.3 | 91.3 | 1.0 |
| Example 13 | | | | | | | | |
| Example 18 | | | 190 | 70 | 48 | 0.3 | 91.1 | 0.9 |
| Comparative | 50/50 | DMF | — | | 45 | 0.2 | 91.2 | 1.0 |
| Example 14 | | | | | | | | |
| Example 19 | | | 195 | 70 | 51 | 0.3 | 91.1 | 1.0 |

TABLE 4

| | Resin composition | | | | Stretching conditions | | Tensile modulus | |
|---|---|---|---|---|---|---|---|---|
| | | Type of | PI/acryl | | | Stretching | (GPa) | |
| | | acrylic | (weight | | Temperature | ratio | First | Second |
| | Polyimide composition | resin | ratio) | Solvent | (° C.) | (%) | direction | direction |
| Comparative | 6FDA/CBDA//TFMB = | 1 | 50/50 | DCM | — | | 3.6 | ND |
| Example 9 | 85/15//100 | | | | | | | |
| Example 14 | | | 50/50 | | 215 | 70 | 5.5 | 3.5 |
| Comparative | CBDA/TAHMBP/ | 1 | 50/50 | DCM | — | | 4.6 | ND |
| Example 10 | ODPA//TFMB/DDS = | | | | | | | |
| Example 15 | 30/50/20//90/10 | | 50/50 | | 215 | 70 | 7.8 | 4.2 |
| Reference | | — | 100/0 | DCM | — | | 5.5 | ND |
| Example 4 | | | | | | | | |
| Comparative | 6FDA/BPADA/ | 1 | 50/50 | DCM | — | | 3.2 | ND |
| Example 11 | PMDA//TFMB/DDS = | | | | | | | |
| Example 16 | 40/20/40//80/20 | 1 | 50/50 | | 200 | 70 | 5.3 | 3.3 |
| Reference | | — | 100/0 | DCM | — | | 4.0 | ND |
| Example 5 | | | | | | | | |
| Comparative | 6FDA//TFMB = | 1 | 50/50 | DMF | — | | 3.3 | ND |
| Example 12 | 100//100 | | | | | | | |
| Example 17 | | | 50/50 | | 180 | 70 | 4.2 | 2.9 |
| Comparative | 6FDA/BPDA//TFMB = | 1 | 50/50 | DMF | — | | 3.5 | ND |
| Example 13 | 60/40//100 | | | | | | | |
| Example 18 | | | 50/50 | | 190 | 70 | 4.5 | 3.1 |
| Comparative | 6FDA/TAHQ/ | 1 | 50/50 | DMF | — | | 3.6 | ND |
| Example 14 | BPDA//TFMB/DDS = | | | | | | | |
| Example 19 | 50/25/25//70/30 | | 50/50 | | 195 | 70 | 5.0 | 3.3 |

| | | | Dynamic bending | | | | |
|---|---|---|---|---|---|---|---|
| | Pencil hardness | | (1000 times) | | Refractive index | | |
| | First | Second | First | Second | | | R |
| | direction | direction | direction | direction | n₁ | n₂ | (%) |
| Comparative | F | ND | 20 | ND | 1.5282 | 1.5279 | 0.02 |
| Example 9 | | | | | | | |
| Example 14 | 2H | H | 550 | 100 | 1.5540 | 1.5129 | 2.72 |
| Comparative | 2H | ND | 10 | ND | 1.5524 | 1.5519 | 0.03 |
| Example 10 | | | | | | | |
| Example 15 | 4H | 4H | 250 | 25 | 1.5787 | 1.5256 | 3.48 |
| Reference | 3H | ND | 200 | ND | 1.6183 | 1.6183 | 0.00 |
| Example 4 | | | | | | | |
| Comparative | F | ND | 10 | ND | 1.5449 | 1.5446 | 0.02 |
| Example 11 | | | | | | | |
| Example 16 | 3H | 2H | 250 | 25 | 1.5636 | 1.5320 | 2.07 |
| Reference | 3H | ND | 200 | ND | 1.6095 | 1.6094 | 0.01 |
| Example 5 | | | | | | | |
| Comparative | H | ND | 5 | ND | 1.5255 | 1.5254 | 0.00 |
| Example 12 | | | | | | | |
| Example 17 | H | H | 490 | 40 | 1.5441 | 1.5152 | 1.90 |
| Comparative | 3H | ND | 10 | ND | 1.5400 | 1.5399 | 0.00 |
| Example 13 | | | | | | | |
| Example 18 | 2H | H | 130 | 36 | 1.5661 | 1.5244 | 2.74 |
| Comparative | H | ND | 10 | ND | 1.5474 | 1.5469 | 0.03 |
| Example 14 | | | | | | | |
| Example 19 | H | H | 75 | 25 | 1.5707 | 1.5349 | 2.34 |

Both the unstretched films of Comparative Examples 1 to 14 containing a polyimide resin and an acryl-based resin and the stretched films of Examples 1 to 19 obtained by stretching these films had a haze of 2% or less and a total light transmittance of 90% or more, and had high transparency similar to the acrylic films of Reference Examples 1 to 3 and the polyimide films of Reference Examples 4 and 5.

As shown in FIG. 1, in the film of Comparative Example 1, no sea-island structure was confirmed in the TEM image, and therefore it was found that the polyimide resin and the acryl-based resin were completely compatible with each other. In addition, in the film of Example 3, no sea-island structure was confirmed in the TEM image as in Comparative Example 1, and therefore it was found that a fully compatible system was maintained even after stretching.

The polyimide film of Reference Example 5 had a yellowness index of 2.3, whereas the films of Comparative Example 11 and Example 16 had a yellowness index smaller than that of Reference Example 5. It was found that by mixing the polyimide with the acryl-based resin, a film with less coloration can be obtained as compared with the case of using the polyimide alone.

In the unstretched film of Comparative Example 1, the film had no in-plane refractive index anisotropy, and the tensile modulus was 3.9 GPa and the endurable number of cycles in the dynamic bending test was 13,000. In Examples 1 to 5 in which the film of Comparative Example 1 was stretched, the index R of the refractive index anisotropy was more than 1.0%, and the refractive index difference tended to increase as the stretching ratio increased.

In Examples 1 to 5, the tensile modulus in the first direction was larger than that in Comparative Example 1, and the tensile modulus in the first direction remarkably increased as the stretching ratio increased. In contrast, the tensile modulus in the second direction tended to decrease as the stretching ratio increased, but the decrease in the tensile modulus in the second direction was slight as compared with the increase in the tensile modulus in the first direction. In the stretched films of Examples 1 to 5, the endurable number of cycles in the first direction was more than 100,000, and the bending resistance was significantly improved as compared with the unstretched film of Comparative Example 1. In Examples 1 to 5, the bending resistance in the second direction was also improved as compared with Comparative Example 1.

Comparison between Comparative Example 2 and Example 6 in which the ratio of the polyimide resin to the acryl-based resin was changed and comparison between Comparative Example 3 and Comparative Example 7 also show that stretching increases the in-plane refractive index difference, increases the tensile modulus in the first direction, and improves the bending resistance in the first direction and the second direction.

In the films of Reference Examples 2 and 3 obtained by stretching the film of the acrylic resin 1 alone, no particular change was observed in the in-plane refractive index difference, and no clear difference was observed in the tensile modulus as compared with the unstretched film of Reference Example 1. In Reference Examples 2 and 3, the bending resistance was lower than that in Reference Example 1.

Comparison between Comparative Examples 4 to 8 and Examples 8 to 13 in which the type of acryl-based resin was changed shows that in the film containing a polyimide and an acryl-based resin, the refractive index anisotropy was increased by stretching, and accordingly, the tensile modulus in the first direction (stretching direction) and the bending resistance in the first direction and the second direction were significantly improved.

Comparison between Comparative Example 9 and Example 14 in which the type of the polyimide resin was changed, comparison between Comparative Example 10 and Example 15, and comparison between Comparative Example 11 and Example 16 showed the same tendency as described above. In Comparative Examples 12 to 14 and Examples 17 to 19, since the polyimide resin and the acrylic resin 1 did not exhibit compatibility in the DCM solvent, films were prepared using DMF as a solvent. It is found that in these examples, the refractive index anisotropy was increased by stretching, and the mechanical strength was significantly improved, as in the examples using DMC as the solvent.

In the unstretched film of Comparative Example 10, the yellowness index was smaller than that of the unstretched film of Reference Example 4, which is made of the polyimide alone, and the transparency was excellent, but the tensile modulus and the bending resistance were inferior to those of Reference Example 4. In contrast, in the film of Example 15 obtained by stretching the film of Comparative Example 10, excellent transparency equivalent to that of Comparative Example 10 was maintained, the tensile modulus and the bending resistance in the first direction were larger than those of Reference Example 4, so that both excellent transparency and excellent mechanical strength were achieved. The film of Reference Example 5 had a yellowness index of 7.5 and thus was colored, but the film of Comparative Example 11 in which the polyimide resin and the acryl-based resin were mixed had a yellowness index of 2.4, and the coloring thereof was greatly suppressed. Comparison of Reference Example 5, Comparative Example 11, and Example 16 showed the same tendency as comparison of Reference Example 5, Comparative Example 11, and Example 16. The film of Example 16 had both excellent transparency and excellent mechanical strength as compared with the polyimide film of Reference Example 5.

The above results show that the film made of the compatible system of the polyimide and the acryl-based resin has excellent transparency comparable to that of a film made of an acryl-based resin alone, and the refractive index anisotropy of such a film is increased by stretching, and accordingly, the tensile modulus in the first direction (stretching direction) and the bending resistance in the first direction and the second direction are significantly improved, so that a transparent film having excellent mechanical strength that cannot be achieved by an acryl-based resin film is obtained.

1. A film comprising:
a polyimide; and
an acryl-based resin, wherein
in a film plane, refractive indices n₁ and n₂ satisfy 100×(n₁−n₂)/n₂≥1.0, where n₁ is a refractive index in a first direction in which the refractive index is a maximum and n₂ is a refractive index in a second direction orthogonal to the first direction, and
the film has a total light transmittance of 85% or more, a haze of 10% or less, and a yellowness index of 5 or less.

2. The film according to claim 1, having a glass transition temperature of 110° C. or higher and lower than 250° C.

3. The film according to claim 1, wherein the polyimide includes:
at least one kind of tetracarboxylic dianhydride selected from the group consisting of fluorine-containing aromatic tetracarboxylic dianhydrides and alicyclic tetracarboxylic dianhydrides, as a tetracarboxylic dianhydride component; and
at least one kind of diamine selected from the group consisting of fluoroalkyl-substituted benzidines and alicyclic diamines, as a diamine component.

4. The film according to claim 3, wherein an amount of the fluoroalkyl-substituted benzidine based on a total amount of the diamine component of the polyimide is 25 mol % or more.

5. The film according to claim 4, wherein the fluoroalkyl-substituted benzidine is 2,2′-bis(trifluoromethyl)benzidine.

6. The film according to claim 3, wherein a total amount of the fluorine-containing aromatic tetracarboxylic dianhydride and the alicyclic tetracarboxylic dianhydride based on a total amount of the tetracarboxylic dianhydride component of the polyimide is 15 mol % or more.

7. The film according to claim 1, wherein a total amount of methyl methacrylate and modified structures of methyl methacrylate is 60 wt % or more based on an amount of all monomer components in the acryl-based resin.

8. The film according to claim 1, wherein the acryl-based resin has a glass transition temperature of 90° C. or higher.

9. The film according to claim 1, containing the polyimide and the acryl-based resin at a weight ratio of 98:2 to 2:98.

10. The film according to claim 1, wherein at least one of a tensile modulus in the first direction and a tensile modulus in the second direction is 4.0 GPa or more.

11. The film according to claim 1, wherein the film is a stretched film that is stretched in at least one direction.

12. A production method of a film, comprising stretching a film in at least one direction, wherein the film contains a polyimide and an acryl-based resin.

13. A production method of the film according to claim 1, comprising stretching an unstretched film in at least one direction, wherein the unstretched film contains a polyimide and an acryl-based resin.

14. The production method of the film according to claim 12, wherein a temperature during the stretching is lower than 250° C.

15. The production method of the film according to claim 12, wherein the unstretched film is produced by applying a resin solution in which the polyimide and the acryl-based resin are dissolved in an organic solvent onto a support, and thereafter removing the organic solvent.

16. An image display device, comprising:
an image display panel; and
the film according to claim 1 arranged on a surface on a viewing side of the image display panel.

17. The image display device according to claim 16, wherein the device is bendable.
